(19) United States
(12) Patent Application Publication
(10) Pub. No.: US 2026/0303177 A1
(43) Pub. Date: Oct. 1, 2026

(54) CHANNEL QUALITY INDICATOR REPORTING FOR SPATIALLY COUPLED MULTIPLE-INPUT MULTIPLE-OUTPUT

(71) Applicant: QUALCOMM Incorporated, San Diego, CA (US)

(72) Inventors: In-Soo KIM, San Diego, CA (US); Yu ZHANG, San Diego, CA (US); Wei YANG, San Diego, CA (US); Kirill IVANOV, La Jolla, CA (US); Yisheng XUE, San Diego, CA (US); Jing SUN, San Diego, CA (US); Jing JIANG, San Diego, CA (US)

(21) Appl. No.: 19/095,237

(22) Filed: Mar. 31, 2025

(51) Int. Cl. H04B 7/06; H04W 24/10; H04W 72/23

(52) U.S. Cl. CPC H04B 7/0632; H04W 24/10; H04W 72/23

(57) ABSTRACT

Various aspects of the present disclosure generally relate to wireless communication. In some aspects, a user equipment (UE) may receive, from a network node, a configuration associated with spatially coupled multiple-input multiple-output (SC-MIMO) communications, wherein the configuration is associated with an initial code block and one or more regular code blocks for one or more bands configured for channel state information (CSI) reporting. The UE may transmit, to the network node and in accordance with the configuration, a CSI report that includes, for each band of the one or more bands, a respective pair of channel quality indicator (CQI) values, wherein a first CQI value of the respective pair of CQI values corresponds to the one or more regular code blocks, and a second CQI value of the respective pair of CQI values corresponds to the initial code block. Numerous other aspects are described.

### FIELD OF THE DISCLOSURE

Aspects of the present disclosure generally relate to wireless communication and specifically relate to techniques, apparatuses, and methods associated with reporting channel quality indicators for spatially coupled multiple-input multiple-output.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a user equipment (UE) may be configured to perform channel quality indicator (CQI) reporting. In some examples, a CQI may be a metric that quantifies a quality of a communication link between the UE and a network node. For example, the UE may perform one or more measurements and obtain one or more parameters, such as a signal-to-noise ratio, a signal-to-interference-plus-noise ratio, or other parameters associated with the quality of the communication link, and the UE may periodically compute the CQI based on the one or more parameters and report the CQI to the network node. The reported CQI may be used by the network node to perform resource allocation, scheduling, selection of a modulation and coding scheme, or selection of other communication parameters, for example.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, a configuration associated with spatially coupled multiple-input multiple-output (SC-MIMO) communications, wherein the configuration is associated with an initial code block and one or more regular code blocks for one or more bands configured for channel state information (CSI) reporting. The processing system may be configured to cause the UE to transmit, to the network node and in accordance with the configuration, a CSI report that includes, for each band of the one or more bands, a respective pair of channel quality indicator (CQI) values, wherein a first CQI value of the respective pair of CQI values corresponds to the one or more regular code blocks, and a second CQI value of the respective pair of CQI values corresponds to the initial code block.

Some aspects described herein relate to a network node. The network node may include a processing system. The processing system may include one or more processors and one or more code-storing memories coupled with the one or more processors. The processing system may be configured to cause the network node to transmit, to a UE, a configuration associated with SC-MIMO communications, wherein the configuration is associated with an initial code block and one or more regular code blocks for one or more bands configured for CSI reporting. The processing system may be configured to cause the network node to receive, from the UE and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Some aspects described herein relate to a method of wireless communication performed by a UE. The method may include receiving, from a network node, a configuration associated with SC-MIMO communications, wherein the configuration is associated with an initial code block and one or more regular code blocks for one or more bands configured for CSI reporting. The method may include transmitting, to the network node and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Some aspects described herein relate to a method of wireless communication performed by a network node. The method may include transmitting, to a UE, a configuration associated with SC-MIMO communications, wherein the configuration is associated with an initial code block and one or more regular code blocks for one or more bands configured for CSI reporting. The method may include receiving, from the UE and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Some aspects described herein relate to a non-transitory computer-readable medium that stores a set of instructions for wireless communication by a UE. The set of instructions, when executed by one or more processors of the UE, may cause the UE to receive, from a network node, a configuration associated with SC-MIMO communications, wherein the configuration is associated with an initial code block and one or more regular code blocks for one or more bands configured for CSI reporting. The set of instructions, when executed by one or more processors of the UE, may cause the UE to transmit, to the network node and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Some aspects described herein relate to a non-transitory computer-readable medium that stores a set of instructions for wireless communication by a network node. The set of instructions, when executed by one or more processors of the network node, may cause the network node to transmit, to a UE, a configuration associated with SC-MIMO communications, wherein the configuration is associated with an initial code block and one or more regular code blocks for one or more bands configured for CSI reporting. The set of instructions, when executed by one or more processors of the network node, may cause the network node to receive, from the UE and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Some aspects described herein relate to an apparatus for wireless communication. The apparatus may include means for receiving, from a network node, a configuration associated with SC-MIMO communications, wherein the configuration is associated with an initial code block and one or more regular code blocks for one or more bands configured for CSI reporting. The apparatus may include means for transmitting, to the network node and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Some aspects described herein relate to an apparatus for wireless communication. The apparatus may include means for transmitting, to a UE, a configuration associated with SC-MIMO communications, wherein the configuration is associated with an initial code block and one or more regular code blocks for one or more bands configured for CSI reporting. The apparatus may include means for receiving, from the UE and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of code block (CB) mapping schemes.

FIG. 4 is a diagram illustrating an example of CB decoding in accordance with spatially coupled multiple-input multiple-output (SC-MIMO) techniques.

FIG. 5 is a diagram illustrating examples of CB mappings in accordance with SC-MIMO techniques.

FIG. 6 is a diagram illustrating examples of channel quality indicator (CQI) reporting.

FIG. 7 is a diagram illustrating examples of assumptions associated with CQI computation for regular CBs in accordance with SC-MIMO techniques.

FIG. 8 is a diagram illustrating examples of assumptions associated with CQI computation for a special CB in accordance with SC-MIMO techniques.

FIG. 9 is a diagram illustrating an example of CQI reporting for candidate special CB locations.

FIG. 10 is a diagram illustrating examples associated with CB mappings for SC-MIMO techniques.

FIG. 11 is a diagram illustrating an example process performed, for example, at a user equipment (UE) or an apparatus of a UE.

FIG. 12 is a diagram illustrating an example process performed, for example, at a network node or an apparatus of a network node.

FIG. 13 is a diagram of an example apparatus for wireless communication.

FIG. 14 is a diagram of an example apparatus for wireless communication.

### DETAILED DESCRIPTION

In some wireless communication systems, a user equipment (UE) may be configured to perform channel quality indicator (CQI) reporting. In some examples, a CQI may be a metric that quantifies a quality of a communication link between the UE and a network node. For example, the UE may perform one or more measurements and obtain one or more parameters, such as a signal-to-noise ratio, a signal-to-interference-plus-noise ratio, or other parameters associated with the quality of the communication link, and the UE may periodically compute the CQI based on the one or more parameters and report the CQI to the network node. The reported CQI may be used by the network node to perform resource allocation, scheduling, selection of a modulation and coding scheme (MCS), or selection of other communication parameters, for example. By accurately assessing the channel quality using CQI reporting, the network node and the UE may improve data transmission rates, enhance spectral efficiency, and support more robust and reliable communications relative to communicating without CQI reporting.

In some examples, multiple-input multiple-output (MIMO) technology may be employed for the wireless communication system to enhance data throughput and link reliability. “MIMO” may generally refer to transmitting or receiving multiple signals (such as multiple layers or multiple data streams) simultaneously over the same time and frequency resources by utilizing multiple antennas at both the transmitter and receiver ends. Some wireless communication systems may use spatially coupled MIMO (SC-MIMO) techniques, which may involve coupling the transmitted data streams across multiple antennas in a coordinated manner. For example, SC-MIMO techniques may include a mapping of a special code block (CB) (e.g., an initial CB, or CB 0) and one or more regular CBs to resources in specific patterns, which may create interdependencies between the data streams. This coupling may allow for more efficient use of the available spatial resources and may significantly enhance the decoding process relative to non-SC-MIMO techniques.

For example, in an SC-MIMO decoding chain, the UE may be configured to decode the special CB before decoding the one or more regular CBs, and the UE may subtract the special CB in a decoding for a first regular CB to be decoded. Subsequent regular CBs may be decoded by subtracting a previous regular CB until all CBs are decoded. Consequently, the subtracting of a previous CB when decoding a subsequent CB may result in half of the CBs associated with a message experiencing inter-layer interference (e.g., inter-CB interference) during decoding, while a remaining half of the CBs do not experience inter-layer interference. Accordingly, SC-MIMO techniques may improve log-likelihood ratio estimation associated with the decoding of the CBs and may allow for simpler receiver implementations relative to non-SC-MIMO techniques.

In some cases, CQI computation and reporting frameworks are designed to be independent of CB mapping patterns. For example, a UE may compute CQI without considering the particular order in which CBs are decoded. Moreover, the UE may be configured to report a single CQI value for each CQI reporting band configured for the UE, and each CQI value may represent a consolidated metric of channel quality across the configured CQI reporting band. However, this approach to CQI computation and reporting does not align well with the operational characteristics of SC-MIMO systems. For example, CQI computation does not account for the mapping of the special CB and the one or more regular CBs, or the interdependencies in the decoding process associated with SC-MIMO techniques. For example, the single CQI value reported by the UE for a reporting band does not provide sufficient granularity to accurately reflect the varying channel conditions experienced by the special CB and by regular CBs in SC-MIMO configurations. Consequently, the CQI computation and reporting may be insufficient when the UE is operating using SC-MIMO techniques, which may degrade the overall system performance, reduce data throughput, and impact the user experience.

Various aspects relate generally to CQI for SC-MIMO. Some aspects more specifically relate to techniques for computing and reporting of CQI by a UE configured for SC-MIMO operations. The UE may receive a configuration, from a network node, that may indicate a special CB and one or more regular CBs for one or more CQI reporting bands (or channel state information (CSI) reporting bands) in accordance with SC-MIMO techniques. In some aspects, the UE may be configured to report, for each CQI reporting band, a pair of CQI values, where a first CQI value of the pair corresponds to the special CB and a second CQI value of the pair corresponds to the one or more regular CBs. In some examples, the configuration may indicate an assumption associated with CQI computing for the one or more regular code blocks. For example, the configuration may indicate that CBs on a first layer (or first half layer) experience interference from CBs on a second layer (or second half layer), while the CBs on the second layer do not experience interference from CBs on the first layer. In some aspects, the assumption indicated by the configuration may be in accordance with a CB mapping associated with the SC-MIMO techniques. For example, a first assumption may correspond to left-to-right diagonal mappings, while a second assumption may correspond to right-to-left diagonal mappings. In some aspects, the UE may be configured to report CQI for one or more candidate locations for the special CB. In some examples, the UE may be configured with a mapping pattern for computing CQI for candidate locations of a first portion of the special CB and a second portion of the special CB. In some aspects, the UE may receive a control message that schedules a data message in accordance with SC-MIMO techniques, and the control message may indicate an MCS for the special CB, a location of the special CB, or a diagonal mapping for the special CB and regular CBs for the data message.

Particular aspects of the subject matter described in this disclosure can be implemented to realize one or more of the following potential advantages. By incorporating a dual CQI reporting scheme, the described techniques can enable a more accurate assessment of the channel conditions for the special CB and regular CBs in SC-MIMO systems, thereby facilitating improved network resource allocation and MCS selection. In some aspects, by indicating assumptions associated with CQI computing for the UE, the UE can refine its CQI computations to accurately account for potential inter-layer interference in accordance with a CB mapping. Accordingly, the UE may compute CQI more precisely relative to using a computing assumption independent from the CB mapping. In some aspects, by configuring the UE to report CQI for candidate locations of the special CB, the network node may select a location for the special CB associated with a greatest channel quality, thereby improving decoding performance for the special CB and subsequent regular CBs in an SC-MIMO decoding chain relative to selecting special CB locations independent of channel quality. Additionally, by configuring the control message that schedules a data message in accordance with SC-MIMO techniques to indicate parameters related to the special CB or the CB mapping, the network node and the UE may experience additional flexibility for SC-MIMO techniques, relative to using fixed parameters or CB mappings.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

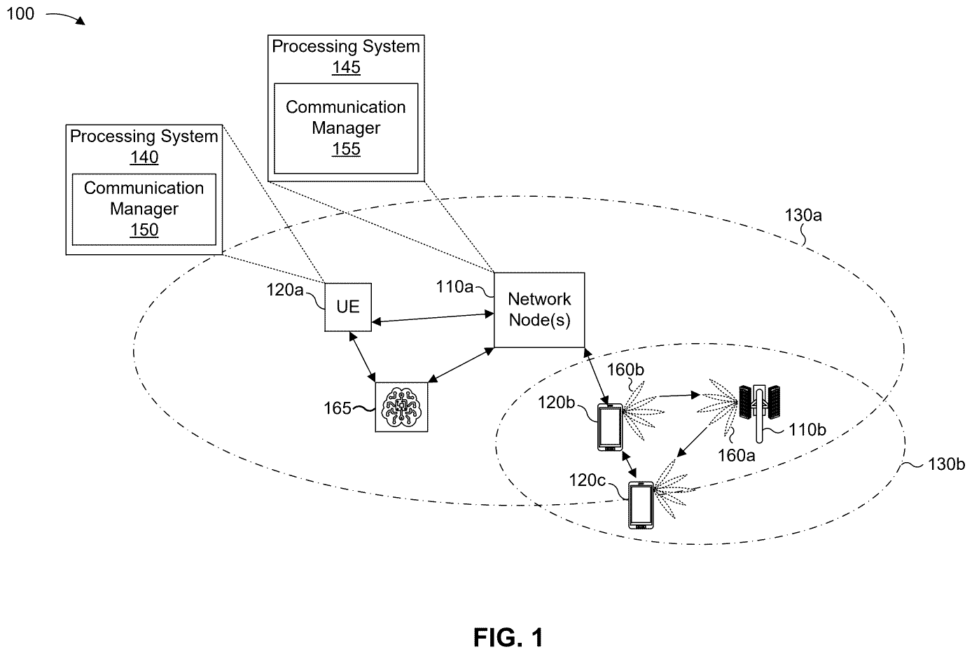

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node 110, a configuration associated with SC-MIMO communications, wherein the configuration is associated with an initial code block and one or more regular code blocks for one or more bands configured for CSI reporting; and transmit, to the network node 110 and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a configuration associated with SC-MIMO communications, wherein the configuration is associated with an initial code block and one or more regular code blocks for one or more bands configured for CSI reporting; and receive, from the UE 120 and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block. Additionally, or alternatively, the communication manager 155 may perform one or more other operations described herein.

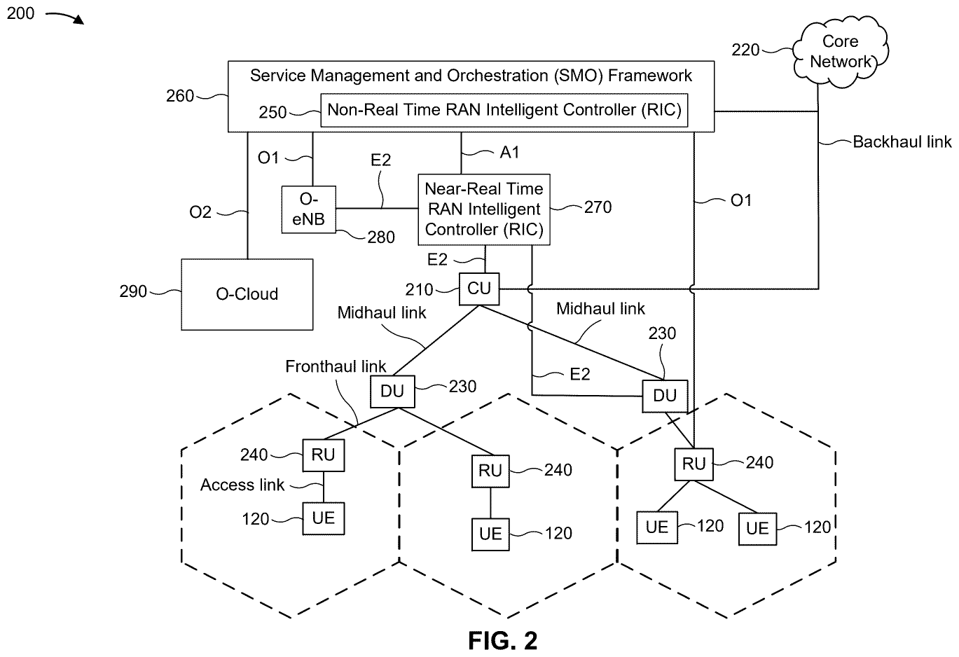

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an 02 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

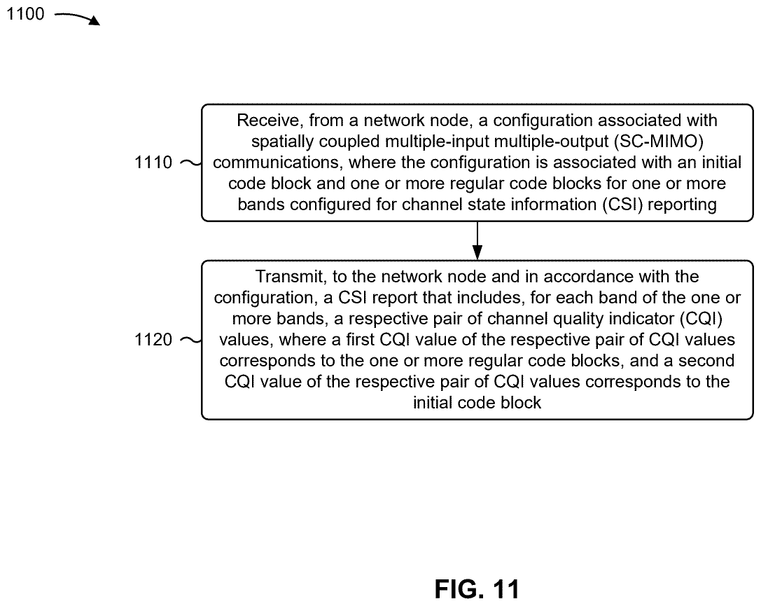

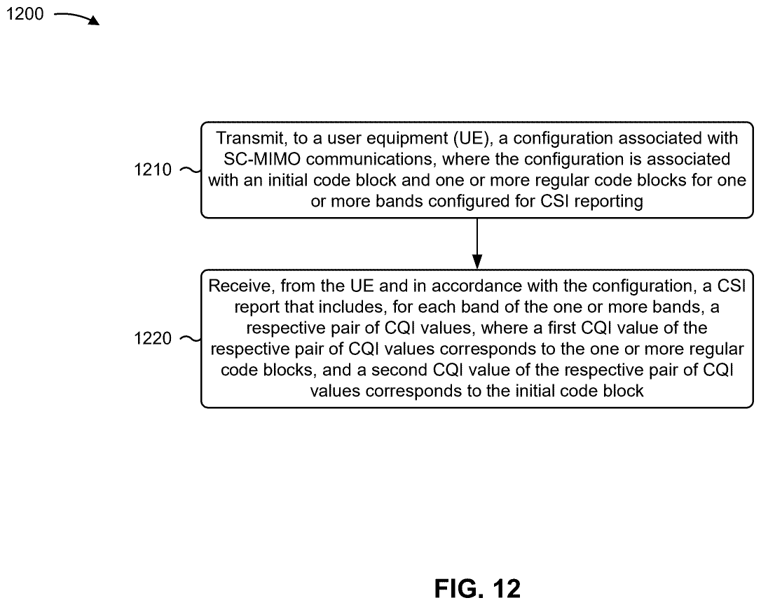

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with CQI computing and reporting for SC-MIMO, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

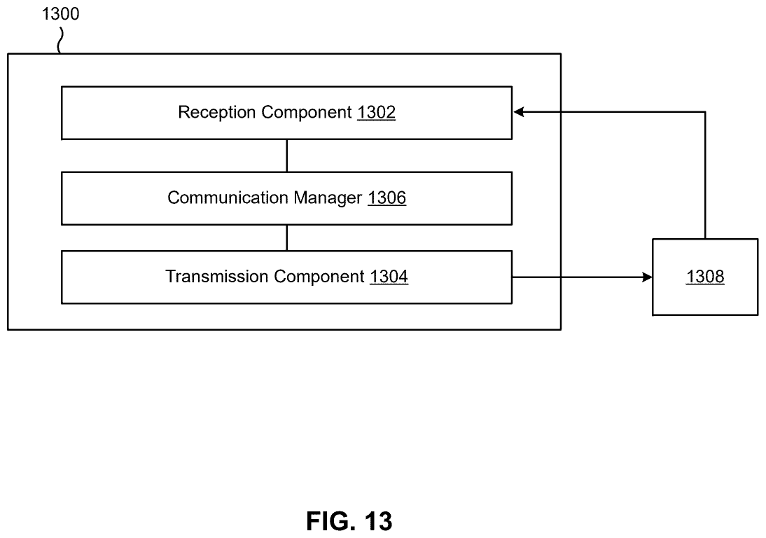

In some aspects, the UE 120 includes means for receiving, from a network node 110, a configuration associated with SC-MIMO communications, wherein the configuration is associated with an initial code block and one or more regular code blocks for one or more bands configured for CSI reporting; or means for transmitting, to the network node 110 and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

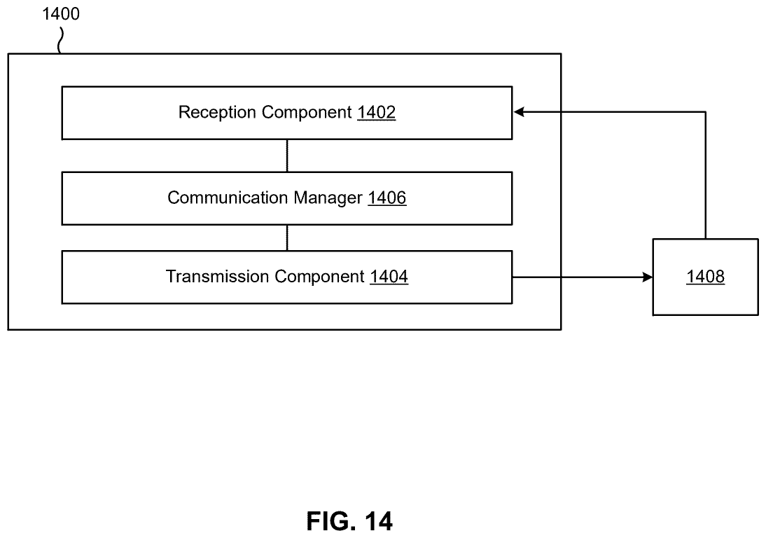

In some aspects, the network node 110 includes means for transmitting, to a UE 120, a configuration associated with SC-MIMO communications, wherein the configuration is associated with an initial code block and one or more regular code blocks for one or more bands configured for CSI reporting; or means for receiving, from the UE 120 and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

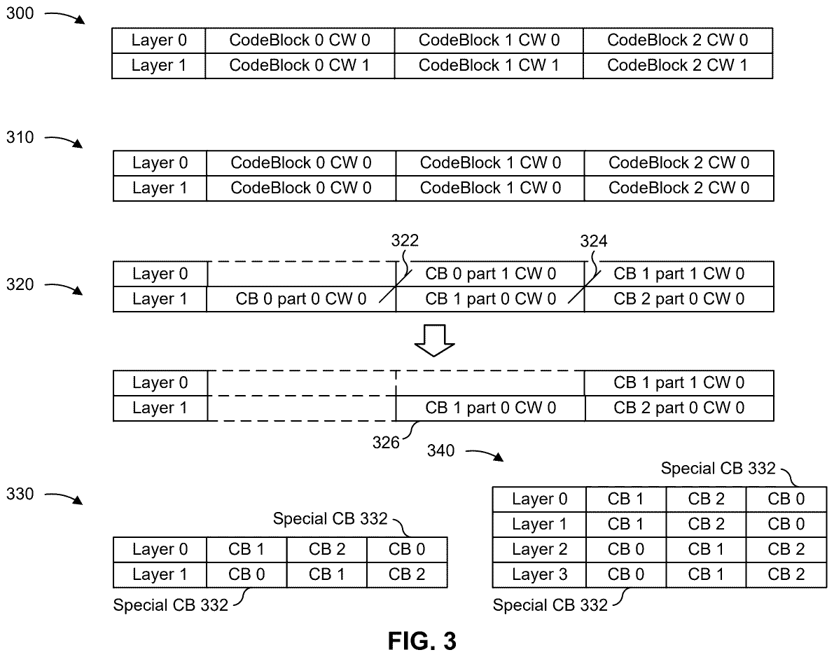

FIG. 3 is a diagram illustrating a first example 300, a second example 310, a third example 320, a fourth example 330, and a fifth example 340 of CB mapping schemes.

In a MIMO system, a transmitter and receiver may simultaneously communicate multiple data streams with one another. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that each antenna of an antenna array transmits respective first signals that, when combined, form the first beam. Similarly, the transmitter may apply a second set of precoding weights to a second signal associated with the second data stream such that each antenna of the antenna array transmits respective second signals that, when combined, form the second beam. In combination, the first signal and the second signal may form a MIMO transmission, and each data stream or each signal may be referred to as a layer of the MIMO transmission. A number or quantity of layers in a MIMO transmission may affect data rate and system performance. For instance, more layers enable the MIMO transmission to carry more independent data streams, resulting in an increased overall throughput or a decreased data transfer latency.

To mitigate recovery errors or increase error correction capabilities in a wireless network, raw user data in a data stream may be processed in multiple steps prior to transmission. For instance, the raw user data may first be segmented into one or more TBs, where each TB is a data unit that is processed by a protocol layer. Channel encoding (e.g., via a polar code, a turbo code, or an LDPC) may be applied to each TB, resulting in a codeword (CW). In some cases, the transmitter may transmit a codeword based at least in part on partitioning the codeword into CBs, and each CB may be independently processed to apply respective error correction or append respective cyclic redundancy check (CRC) bits to the CB.

With regard to a MIMO transmission, a transmitter may map a codeword (and the corresponding CBs) to a same MIMO layer or different MIMO layers. To illustrate, the first example 300 shows a long term evolution (LTE) dual CW MIMO-based mapping scheme for mapping multiple CWs to multiple layers, such as Layer 0 and Layer 1 of a MIMO transmission. For instance, LTE specifies a first codeword, CW0, as a primary codeword or a primary data stream. Single layer transmissions, such as a single-input, single-output (SISO) transmission, always and only carry CW0. LTE also specifies a second codeword, CW1, as a secondary codeword or a secondary data stream that is separate and independent of the first codeword CW0. Accordingly, every channel may carry or use CW0, and channels that are configured to carry multiple layers, such as PDSCH, may additionally carry CW1 (e.g., for user data). Alternatively, or additionally, MIMO transmissions (e.g., that use spatial multiplexing or polarization multiplexing) may carry both CW0 and CW1 in different layers.

The first CB mapping scheme in the first example 300 may be referred to as an LTE dual CW mapping scheme that is based at least in part on time-frequency resources that are allocated to a MIMO transmission. To illustrate, the first example 300 includes two rows of time-frequency resources: a first row of time-frequency resources that are allocated to Layer 0 of the MIMO transmission and a second row of time-frequency resources that are allocated to Layer 1 of the MIMO transmission. The time-frequency resources for each row are partitioned into respective CB resources, and the CB resources may include or represent one or more time-frequency resources. To illustrate, a first CB resource in the Layer 0 row (e.g., a first partition) may include or represent one or more first time-frequency resources that are allocated to a first portion of a Layer 0 data transmission (e.g., a first CB carried by Layer 0). In a similar manner, a second CB resource in the Layer 0 row (e.g., a second partition) may include or represent one or more second time-frequency resources that are allocated to a second portion of the Layer 0 data transmission (e.g., a second CB carried by Layer 0), and the third CB resource in the Layer 0 row (e.g., a third partition) may include or represent one or more third time-frequency resources that are allocated to a third portion of the Layer 0 data transmission. A time-frequency resource and, consequently, a CB resource, may be based at least in part on any type of frequency partition or any type of time partition, such as a carrier, a sub-carrier, a sub-band, an RB, a resource element (RE), a time slot, a symbol, or a mini slot. In some cases, the CB resources between layers may share one or more time-frequency resources based at least in part on a MIMO transmission using a multiplexing scheme (e.g., spatial multiplexing, polarization multiplexing) that separates each layer. Accordingly, a first CB resource in Layer 0 may share one or more time-frequency resources with a first CB resource in Layer 1.

In the LTE dual CW mapping scheme, a transmitter may partition CW0 into a first set of CBs (shown as CB 0 CW0, CB 1 CW0, and CB 2 CW0), and CW1 into a second set of CBs (shown as CB 0 CW1, CB 1 CW1, and CB 2 CW1). Based at least in part on using the first CB mapping scheme, the transmitter may assign CW0 to a first layer (e.g., Layer 0) such that each CB of CW0 is mapped to (and subsequently carried by) a respective CB resource of Layer 0. The transmitter may also assign each CB of CW1 to a second layer (e.g., Layer 1) such that each CB of CW1 is mapped to (and subsequently carried by) a respective CB resource of Layer 1. In some cases, the transmitter may use different code rates or modulation schemes (e.g., different MCSs) for the Layer 0/CW0 transmission and the Layer 1/CW1 transmission.

A receiver may decode or recover CW0 and CW1 based at least in part on using successive interference cancellation (SIC) or hard SIC (HSIC). For instance, the receiver may receive a first signal and a second signal as a combined signal, such as Layer 0 and Layer 1 of a MIMO transmission. The receiver may decode the first signal and subtract the first signal from the combined signal to generate a difference signal. The receiver may then decode the difference signal as the second signal. Accordingly, in using SIC to decode or recover CW0 and CW1 from the first signal and the second signal, the receiver may iteratively subtract detected signals from a combined signal to improve the detection of the remaining signal (e.g., the difference signal). Using the LTE dual CW mapping scheme of the first example 300 in combination with SIC signal processing may enable a transmitter and receiver to achieve (or approach) a MIMO capacity. Alternatively, or additionally, the receiver may use linear minimum mean squared error (LMMSE) signal processing to improve data recovery (e.g., reduce receiver errors) in decoding the first signal and improve the effectiveness of SIC in subsequent signal decoding. Approaching or achieving the MIMO capacity through the use of LTE dual CW mapping may, in some cases, be based at least in part on per-CW CQI feedback having a certain amount of accuracy within a time threshold or using separate outer-loop control mechanisms that adjust a target CQI for each CW.

The second example 310 shown by FIG. 3 is a second CB mapping scheme that may be referred to as a single CW mapping with an irregular LDPC or as a NR single CW0 mapping scheme. The second CB mapping scheme in the second example 310 may be based at least in part on time-frequency resources that are allocated to a MIMO transmission in a similar manner as described with regard to the first example 300 (e.g., CB resources).

As shown by FIG. 3, a transmitter may partition the single CW0 into multiple CBs or may partition each CB into multiple CB partitions. The transmitter may then map a respective CB partition to a respective layer of a MIMO transmission. For instance, with regard to a 2-layer MIMO transmission, the transmission may assign a first CB partition of a first CB to Layer 0 and a second CB partition of the first CB to Layer 1, which is shown by FIG. 3 as CB 0 CW0 assigned to Layer 0 and CB 0 CW0 assigned to Layer 1, respectively. The transmitter may repeat the CB partitioning for each CB of CW0 such that each layer is assigned a respective CB partition of each CB, which is further shown by FIG. 3 as CB 1 CW0 assigned to Layer 0, CB 1 CW0 assigned to Layer 1, CB 2 CW0 assigned to Layer 0, and CB 2 CW0 assigned to Layer 1.

In the second example 310, each layer transmission may be independent from one another such that a receiver may decode each layer independently or without using information from the other layers. Alternatively, or additionally, each layer may be assigned a respective MCS or may experience different channel conditions relative to one another. To reduce decoding errors or to increase data throughput in a manner that results in a MIMO transmission that approaches or achieves a MIMO capacity, a receiver may use non-linear MIMO demodulation techniques, such as iterative SIC, across all of the MIMO layers. However, based at least in part on a transmitter using different MCSs for each layer, a MIMO transmission may deviate from an assumption of uniformly distributed noise (e.g., additive white Gaussian noise (AWGN)). This deviation may make NR LDPC decoding suboptimal for iterative demodulation or decoding processes. Consequently, the NR single CW0 mapping scheme in NR in the second example 310 may be suboptimal relative to an LTE dual CW mapping scheme in some scenarios, such as scenarios in which there is significant channel condition variation across the layers. That is, a MIMO transmission that is based at least in part on LDPC encoding/decoding may achieve higher data throughput using the LTE dual CW mapping scheme relative to the NR single CW 0 mapping scheme in scenarios in which there is significant variation in the channel conditions across the layers.

A transmitter may use SC-MIMO to improve a robustness, reliability, or data throughput for LDPC-based MIMO transmissions in scenarios where there is significant variation in channel conditions across the MIMO layers. More particularly, SC-MIMO may use a mapping scheme that increases a coupling between MIMO layers using a structured dependency between the layers such that a MIMO layer may be decoded using at least some information from another MIMO layer, resulting in increased robustness, reliability, or data throughput. To illustrate, a single codeword (e.g., CW0) may be partitioned into multiple independent CBs, and each independent CB may be partitioned into multiple CB partitions. To increase a coupling between MIMO layers, an SC-MIMO CB mapping scheme may use a structured dependency that maps a first CB partition of a first independent CB to a first layer and a second CB partition of a second independent CB to a second layer such that the first CB partition is transmitted simultaneously with the second CB partition via different layers. A receiver may use SIC to subtract the first CB partition from the second CB partition (or vice versa) to improve data recovery for the remaining signal “Spatial coupling” may denote the inter-layer coupling that is based at least in part on the structured dependency.

The third example 320 is an example of a third CB mapping scheme that may also be referred to as an SC-MIMO-based mapping scheme for a single CW0. The third CB mapping scheme shown by FIG. 3 may be based at least in part on the time-frequency resources or the CB resources described with regard to the first example 300 and the second example 310. In some aspects, a transmitter using an SC-MIMO-based mapping scheme may select a single CW rate (e.g., a uniform MCS for all layers) to match a collective channel quality across the multiple layers of a MIMO transmission.

In a similar manner as described with regard to the second example 310, a transmitter may partition each CB of a single CW (e.g. CW0) into CB partitions and may map a respective CB partition of each CB to a respective layer of a MIMO transmission. As shown by FIG. 3, the third CB mapping scheme of the third example 320 may be based at least in part on a structured dependency or a spatial coupling between the different MIMO layers such that at least a first portion of a first MIMO layer may be decoded using at least some information from a second portion of a second MIMO layer.

To illustrate, as shown by FIG. 3, Layer 0 and Layer 1 may each be assigned three respective CB resources in a similar manner as described above: a first Layer 0 CB resource and a first Layer 1 CB resource, a second Layer 0 CB resource and a second Layer 1 CB resource, and a third Layer 0 CB resource and a third Layer 1 CB resource. Each CB resource may include or represent one or more time-frequency resources that are assigned to the respective MIMO layer. In some aspects, a transmitter may map CB partitions of a CB across different MIMO layers using the structured dependency between the CB resources. For instance, based at least in part on a first structured dependency 322, the transmitter may map a first CB partition of a first code word to a first CB resource of Layer 1 (shown as CB 0 part 0 CW0) and a second CB partition of the first code word to a second CB resource of Layer 0 (shown as CB 0 part 1 CW0). Alternatively, or additionally, based at least in part on a second structured dependency 324, the transmitter may map a first CB partition of a second CB to a second CB resource of Layer 1 (shown as CB1 part 0 CW0) and a second CB partition of the second CB (shown as CB1 part 1 CW0) to a third CB resource of Layer 0.

A receiver may decode or de-map the information carried in the CB resources (e.g., the CB partitions) based at least in part on the structured dependencies that enable the receiver to use SIC as at least part of a demodulating process or a decoding process. For instance, the receiver may begin the decoding process by decoding a first CB (e.g., in the first CB resource of Layer 1 and the second CB resource of Layer 0). Based at least in part on successful decoding, the receiver may subtract the first CB from a composite received signal to obtain a difference signal as shown by reference number 326, and may demodulate or decode a second CB using the second CB resource of Layer 1 and the third CB resource of Layer 0. Based at least in part on successful decoding, the receiver may repeat the process of subtracting the most recently decoded signal from the composite received signal and demodulating/decoding the difference signal until all of the CBs are successfully decoded or a CB decoding failure is declared.

Some mapping schemes for SC-MIMO may include a special CB, which may also be referred to as an interference-mitigating CB, an initial CB, or CB 0, and the special CB may be designed to enable successful decoding without the use of SIC by a receiver. For instance, an interference-mitigating CB or a special CB may be transmitted with a reduced transmit power level or with a lower MCS relative to another CB being simultaneously transmitted via another layer. Additionally, the special CB may be associated with a decoding start (e.g., the special CB may be decoded first relative to other CBs).

The fourth example 330 shown by FIG. 3 is an example SC-MIMO-based mapping scheme that is similar to the SC-MIMO-based mapping scheme in which the transmitter places a special CB 332 in a CB resource that is linked to a decoding start. For instance, a receiver may begin decoding in a first CB resource of Layer 1 (e.g., CB 0 part 0 CW0) and a second CB resource of Layer 0. To mitigate interference with the first portion of the first CB carried by Layer 1 in the first CB resource, the transmitter may transmit the special CB 332 in a first CB resource of Layer 0 (e.g., simultaneously with the first CB carried by Layer 1). For example, the transmitter may transmit the special CB 332 with a reduced transmit power level relative to a transmission in the first CB resource of Layer 1. Based at least in part on successful decoding of the first CB, the receiver may perform successive decoding based at least in part on SIC in a similar manner as described above. The successive decoding by the receiver may be performed in a single direction (e.g., starting at the first CB resource and ending at the third CB resource), or may be performed in both directions in parallel (e.g., starting at both the first CB resource and the third CB resource). Alternatively, or additionally, a receiver may change a decoding direction based at least in part on observing a decoding failure.

The fifth example 340 shown by FIG. 3 is an example SC-MIMO-based mapping scheme that is similar to the SC-MIMO-based mapping scheme of example 330, but supporting a larger quantity of layers relative to the example 330. For example, the example 340 includes the Layer 0, the Layer 1, a Layer 2, and a Layer 3. In some examples, portions of a CB may span multiple layers. For example, a first portion of the special CB 332 may be transmitted via one or more CB resources spanning the Layer 2 and the Layer 3, and a second portion of the special CB 332 may be transmitted via one or more CB resources spanning the Layer 0 and the Layer 1. Similarly, a first portion of CB 1 and CB 2 may span the Layer 2 and the Layer 3, and a second portion of the CB1 and the CB 2 may span the Layer 0 and the Layer 1. Additionally, or alternatively, each of the regular CBs and the special CB 332 may include four portions, where each portion is located in each layer. While FIG. 3 illustrates examples having 2-layer or 4-layer CB mappings, SC-MIMO CB mappings may include a different quantity of layers.

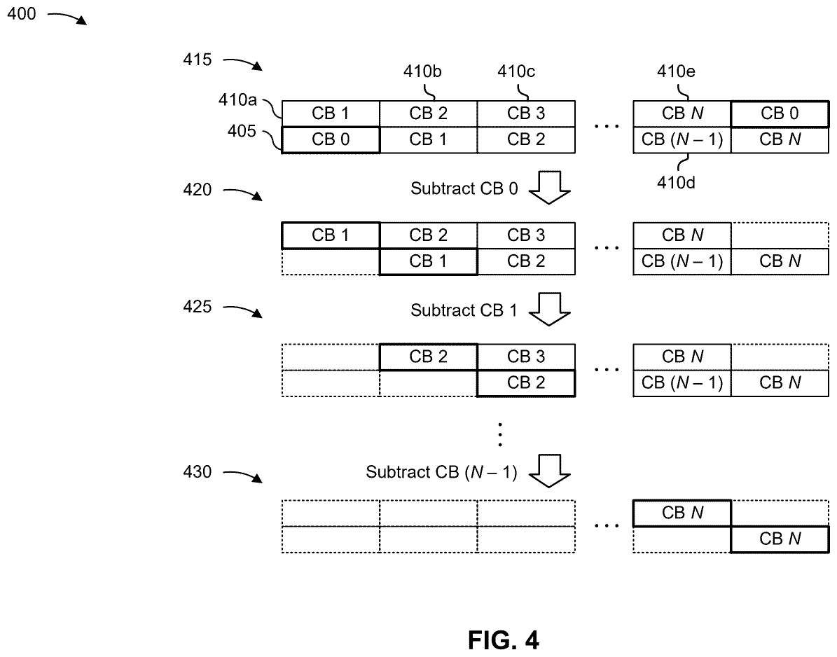

In some examples, for an SC-MIMO CB mapping, the one or more regular CBs (e.g., CB 1 and CB 2) may be associated with a first MCS (e.g., MCS_{rg}) and the special CB 332 may be associated with a second MCS (e.g., MCSₛₚ). The first MCS associated with the one or more regular CBs may be identical for all regular CBs across a TB. In some cases, the second MCS associated with the special CB 332 may be configured as a function of the first MCS. For example, a UE 120 may be configured with an offset value, such that the second MCS may be offset from a first MCS in accordance with the offset value. In some cases, the second MCS may be lower than the first MCS by the first offset value. For example, when the offset value is three, the second MCS may be given by MCSₛₚ=MCS_{rg}−3. Decoding for SC-MIMO-based mapping schemes is described in more detail with reference to FIG. 4.

In some aspects, a UE 120 may receive a configuration, from a network node 110, that may indicate a special CB 332 and one or more regular CBs for one or more CQI reporting bands in accordance with SC-MIMO techniques. In some aspects, the UE 120 may be configured to report, for each CQI reporting band, a pair of CQI values, where a first CQI value of the pair corresponds to the special CB 332 and a second CQI value of the pair corresponds to the one or more regular CBs. In some examples, the configuration may indicate an assumption associated with CQI computing for the one or more regular code blocks. For example, the configuration may indicate that CBs on a first layer (e.g., Layer 0) experience interference from CBs on a second layer (e.g., Layer 1), while the CBs on the second layer do not experience interference from CBs on the first layer, or vice-versa. In some aspects, the assumption indicated by the configuration may be in accordance with a CB mapping associated with the SC-MIMO techniques. For example, a first assumption may correspond to left-to-right diagonal mappings, while a second assumption may correspond to right-to-left diagonal mappings. In some aspects, the UE may be configured to report CQI for one or more candidate locations for the special CB. In some examples, the UE may be configured with a mapping pattern for computing CQI for candidate locations of a first portion of the special CB 332 and a second portion of the special CB 332.

As indicated above, FIG. 3 is provided as an example. Other examples may differ from what is described with respect to FIG. 3.

FIG. 4 is a diagram illustrating an example 400 of CB decoding in accordance with SC-MIMO techniques. The example 400 illustrates decoding for an SC-MIMO mapping that includes a special CB 405 (e.g., an initial CB, illustrated as CB 0) and regular CBs 410, such as a first regular CB 410a (illustrated as CB 1), a second regular CB 410b (illustrated as CB 2), a third regular CB 410c (illustrated as CB 3), a fourth regular CB 410d (illustrated as CB N−1), and a fifth regular CB 410e (illustrated as CB N). In some examples, the decoding may be performed at a UE 120, as described herein.

In a first decoding step 415, which may be a first step of an SC-MIMO decoding chain, the special CB 405 may be decoded. In some examples, the special CB 405 may include a first portion on a first layer (or half layer) and a second portion on a second layer (or half layer), and the decoding may include decoding each portion of the special CB 405. The special CB 405 may then be subtracted to perform decoding for a subsequent regular CB 410. For example, a contribution of the special CB 405 may be subtracted from a received signal. Additionally, or alternatively, the first portion of the special CB 405 may be subtracted from a portion of the signal to isolate a first portion of the first regular CB 410a, and a second portion of the special CB 405 may be subtracted from a portion of the signal to isolate a second portion of the fifth regular CB 410e, in accordance with an SC-MIMO CB mapping.

In a second decoding step 420, the first regular CB 410a may be decoded in accordance with subtracting the special CB 405. For example, the first portion of the first regular CB 410a may be decoded, and the first portion of the first regular CB 410a may not experience inter-CB interference (e.g., inter-layer interference) in accordance with the subtracting of the first portion of the special CB 405. Additionally, a second portion of the first regular CB 410a may be decoded, and the second portion of the first regular CB 410a may experience inter-CB interference from a first portion of the second regular CB 410b. The first regular CB 410a may then be subtracted to perform decoding for a subsequent regular CB 410 (e.g., the second regular CB 410b). For example, the first portion and the second portion of the first regular CB 410a may be subtracted, which may isolate the first portion of the second regular CB 410b.

In a third decoding step 425, the second regular CB 410b may be decoded in accordance with subtracting the first regular CB 410a. For example, the first portion of the second regular CB 410b may be decoded, and the first portion of the second regular CB 410b may not experience inter-CB interference in accordance with the subtracting of the first portion of the first regular CB 410a. Additionally, a second portion of the first regular CB 410a may be decoded, and the second portion of the first regular CB 410a may experience inter-CB interference from a first portion of the third regular CB 410c. The second regular CB 410b may then be subtracted to perform decoding for a subsequent regular CB 410 (e.g., the third regular CB 410c). For example, the first portion and the second portion of the second regular CB 410b may be subtracted which may isolate the first portion of the third regular CB 410c.

The decoding may continue for each regular CB 410 with the decoding and subtracting of each regular CB 410. For example, in a fourth decoding step 430, the fifth regular CB 410e may be decoded in accordance with a subtracting of the fourth regular CB 410d. For example, a first portion and a second portion of the fifth regular CB 410e may be decoded. The first portion and the second portion of the fifth regular CB 410e may not experience inter-CB interference in accordance with the subtracting of the second portion of the special CB 405 and a first portion of the fourth regular CB 410d. Accordingly, by implementing the SC-MIMO decoding chain, inter-CB interference is experienced on half of the decoded portions (e.g., for all of the regular CBs 410 and the special CB 405), while the other half of the decoded portions do not experience inter-CB interference.

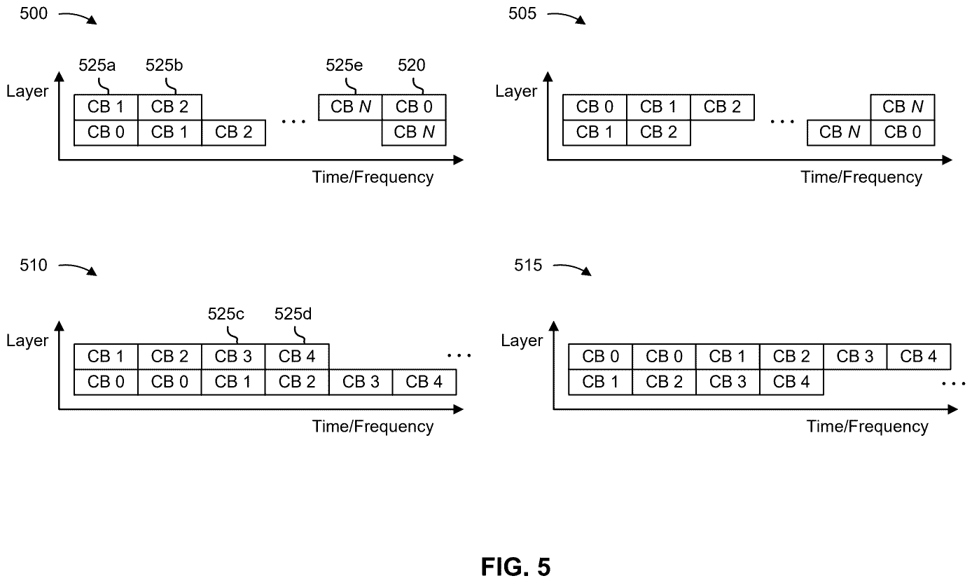

In some aspects, the UE 120 may be configured to report, for each CQI reporting band, a pair of CQI values, where a first CQI value of the pair corresponds to the special CB 405 and a second CQI value of the pair corresponds to the regular CBs 410. In some examples, the configuration may indicate an assumption associated with CQI computing for the one or more regular CBs 410. For example, the configuration may indicate that regular CBs 410 (or portions thereof) located on a first layer experience inter-CB interference from CBs on a second layer, while the regular CBs 410 on the second layer do not experience interference from CBs on the first layer. In some aspects, the assumption indicated by the configuration may be in accordance with a CB mapping associated with the SC-MIMO techniques. For example, the assumption may correspond to right-to-left diagonal mappings, as shown in the example 400. Additional examples of CB mappings are described with reference to FIG. 5.

As indicated above, FIG. 4 is provided as an example. Other examples may differ from what is described with respect to FIG. 4. For example, the decoding may be performed in accordance with different CB mappings, which may result in different CBs not experiencing inter-CB interference. Additionally, or alternatively, different quantities of CBs or layers may be used than shown in FIG. 4.

FIG. 5 is a diagram illustrating a first example 500, a second example 505, a third example 510, and a fourth example 515 of CB mappings in accordance with SC-MIMO techniques. The examples illustrate CB mappings that include a special CB 520 (e.g., an initial CB, illustrated as CB 0) and regular CBs 525, such as a first regular CB 525a (illustrated as CB 1), a second regular CB 525b (illustrated as CB 2), a third regular CB 525c (illustrated as CB 3), a fourth regular CB 525d (illustrated as CB 4), and a fifth regular CB 525e (illustrated as CB N) associated with an SC-MIMO transmission (e.g., an SC-MIMO PDSCH message transmission).

The example 500 illustrates a first CB mapping type. In some examples, the first CB mapping type may be referred to as a right-to-left diagonal mapping type (or a top-left-to-bottom-right diagonal mapping). For example, between a first layer (or half layer) and a second layer, CBs may be shifted from right to left (e.g., in a time, frequency, or time-frequency axis). For instance, a first portion of the first regular CB 525a may be in a first resource (e.g., a time, frequency, or time-frequency resource) of the first layer, and a second portion of the first regular CB 525a may be in a second resource of the second layer that is shifted to the left (e.g., by one RE). Other regular CBs 525 may be shifted in a similar manner. In some examples, when a first portion of a CB is in a left-most location (e.g., a left-most RE in the time, frequency, or time-frequency axis) of a set of resources associated with the SC-MIMO transmission, a second portion of the CB may be mapped to a right-most resource. For example, as shown by the example 500, a first portion of the special CB 520 is mapped to the left-most resource of the first layer, and a second portion of the special CB 520 is mapped to the right-most resource of the second layer.

The example 505 illustrates a second CB mapping type. In some examples, the second CB mapping type may be referred to as a left-to-right diagonal mapping type (or a bottom-left-to-top-right diagonal mapping). For example, between the first layer and the second layer, CBs may be shifted from left to right (e.g., in a time, frequency, or time-frequency axis). For instance, the first portion of the first regular CB 525a may be in a first resource (e.g., a time, frequency, or time-frequency resource) of the first layer, and a second portion of the first regular CB 525a may be in a second resource of the second layer that is shifted to the right (e.g., by one RE). Other regular CBs 525 may be shifted in a similar manner. In some examples, when a first portion of a CB is in a right-most location (e.g., in the time, frequency, or time-frequency axis) of a set of resources associated with the SC-MIMO transmission, a second portion of the CB may be mapped to a left-most resource. For example, as shown by the example 500, the first portion of the special CB 520 is mapped to the right-most resource of the first layer, and the second portion of the special CB 520 is mapped to the left-most resource of the second layer.

The example 510 illustrates a third CB mapping type. In some examples, the first CB mapping type may be a right-to-left diagonal mapping type where the special CB 520 is located entirely on one layer. For example, the first portion of the special CB 520 and the second portion of the special CB 520 may be located on corresponding resources of the first layer. In some examples, the regular CBs 525 may be shifted from right to left in accordance with the position of the special CB 520. For example, between the first layer and the second layer, CBs may be shifted from right to left by two resources (e.g., time, frequency, or time-frequency resources). For instance, the first portion of the first regular CB 525a may be in a first resource (e.g., a time, frequency, or time-frequency resource) of the first layer, and the second portion of the first regular CB 525a may be in a second resource of the second layer that is shifted to the left by two resources. Other regular CBs 525 may be shifted in a similar manner.

The example 515 illustrates a fourth CB mapping type. In some examples, the first CB mapping type may be a left-to-right diagonal mapping type where the special CB 520 is located entirely on one layer. For example, the first portion of the special CB 520 and the second portion of the special CB 520 may be located on corresponding resources of the second layer. In some examples, the regular CBs 525 may be shifted from left to right in accordance with the position of the special CB 520. For example, between the first layer and the second layer, CBs may be shifted from left to right by two resources (e.g., time, frequency, or time-frequency resources). For instance, the first portion of the first regular CB 525a may be in a first resource (e.g., a time, frequency, or time-frequency resource) of the first layer, and the second portion of the first regular CB 525a may be in a second resource of the second layer that is shifted to the left by two resources. Other regular CBs 525 may be shifted in a similar manner.

In some aspects, a UE 120 may be configured to report, for each CQI reporting band, a pair of CQI values, where a first CQI value of the pair corresponds to the special CB 520 and a second CQI value of the pair corresponds to the regular CBs 525. In some examples, the configuration may indicate an assumption associated with CQI computing for the one or more regular CB 525. In some aspects, the assumption indicated by the configuration may be in accordance with a CB mapping associated with the SC-MIMO techniques. For example, for right-to-left diagonal mapping types, the configuration may indicate that regular CBs 525 (or portions thereof) located on the first layer experience inter-CB interference from CBs on the second layer, while the regular CBs 525 on the second layer do not experience interference from CBs on the first layer. Additionally, or alternatively, for left-to-right diagonal mapping types, the configuration may indicate that regular CBs 525 (or portions thereof) located on the second layer experience inter-CB interference from CBs on the first layer, while the regular CBs 525 on the first layer do not experience interference from CBs on the second layer. In some aspects, the UE 120 may receive an indication of a mapping type to be used for SC-MIMO communications via a configuration (e.g., an RRC configuration). Additionally, or alternatively, a default mapping type may be configured to the UE 120 (e.g., the default mapping type may be defined in a specification).

As indicated above, FIG. 5 is provided as an example. Other examples may differ from what is described with respect to FIG. 5. For example, the quantity of resources that CBs are shifted between layers may be different than as shown in the examples in FIG. 5. Additionally, or alternatively, the location of the special CB 520 may be different than as shown in the examples in FIG. 5. In some examples, the quantity of layers (or half layers) or the quantity of regular CBs 525 may be different than as shown in the examples in FIG. 5.

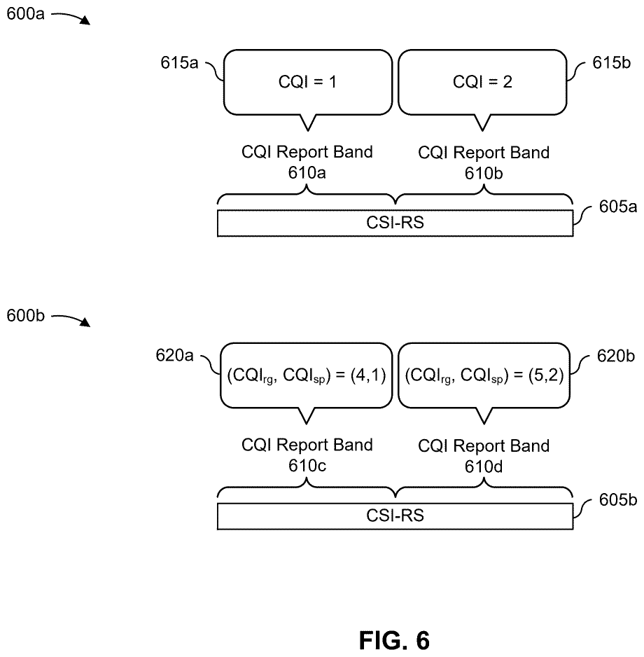

FIG. 6 is a diagram illustrating a first example 600a and a second example 600b of CQI reporting. The first example 600a and the second example 600b may illustrate CQI reporting in accordance with a CSI-RS 605, which may be transmitted by a network node 110 and measured by a UE 120. In some aspects, the UE 120 may be configured with one or more CQI report bands 610 associated with the CSI-RS. For example, the UE 120 may be configured to compute and report CQI for each CQI report band 610 configured to the UE 120 (e.g., via a configuration, such as a CSI measurement or CSI reporting configuration).

As shown by the first example 600a, the UE 120 may be configured to obtain (e.g., compute) CQI values 615 for each CQI report band 610 associated with a CSI-RS 605a. For example, the UE 120 may be configured to obtain and report CQI values 615a and 615b for a CQI report band 610a and a CQI report band 610b, respectively, associated with the CSI-RS 605a. In some examples, the UE 120 may obtain a first CQI value 615a associated with the first CQI report band 610a (e.g., in accordance with measurements of the CSI-RS 605a on the first CQI report band 610a), and the UE 120 may obtain a second CQI value 615b associated with the second CQI report band 610b.

However, this approach to CQI computation and reporting may not align well with the SC-MIMO techniques. For example, the CQI computation shown by example 600a may not account for the mapping of a special CB and regular CBs included in an SC-MIMO CB mapping. Additionally, by obtaining a single CQI value 615 for each CQI report band 610, the CQI reporting by the UE 120 for each CQI reporting band 610 may not provide sufficient granularity to accurately reflect the varying channel conditions experienced by the special CB and by the regular CBs.

Accordingly, as shown by the second example 600b, the UE 120 may be configured (e.g., by a network node 110, such as via a configuration associated with CSI reporting or with SC-MIMO) to report multiple CQI values for each CQI report band 610. For example, the UE 120 may be configured to report a pair of CQI values 620. In some aspects, each pair of CQI values 620 may include a first CQI value corresponding to the regular CBs and a second CQI value corresponding to the special CB. For example, the UE 120 may be configured to compute a first CQI value (e.g., CQI_{rg}) associated with measurements corresponding to the regular CBs (e.g., locations associated with the regular CBs), and the UE 120 may be configured to compute a second CQI value (e.g., CQIₛₚ) associated with measurements corresponding to the special CB (e.g., locations associated with the regular CB).

In some aspects, the UE 120 may be configured to report a first pair of CQI values 620a corresponding to a CQI report band 610c of a CSI-RS 605b, and the first pair of CQI values 620a may include a first CQI value corresponding to the regular CBs associated with the CQI report band 610c and a second CQI value corresponding to the special CB associated with the CQI report band 610c. Additionally, the UE 120 may be configured to report a second pair of CQI values 620b corresponding to a CQI report band 610d of the CSI-RS 605b, and the second pair of CQI values 620b may include a third CQI value corresponding to the regular CBs associated with the CQI report band 610d and a fourth CQI value corresponding to the special CB associated with the CQI report band 610d.

In some aspects, the UE 120 may be configured to report the pairs of CQI values 620 in accordance with a configuration received from a network node 110. For example, the configuration may configure the UE 120 to report CQI using multiple mappers associated with the UE 120, such as an SC-MIMO mapper and an NR mapper. In some cases, the configuration may be transmitted in accordance with a capability associated with the UE 120. For example, the UE 120 may transmit, to the network node, a capability report that indicates a capability of the UE 120 to support the SC-MIMO mapper. In some aspects, the network node 110 may configure the UE 120 to transmit the pairs of CQI values 620 (e.g., corresponding to the SC-MIMO mapper and the NR mapper) in accordance with reception of the capability report indicating the capability of the UE 120 to support the SC-MIMO mapper.

Accordingly, the UE 120 may support CQI reporting associated with regular CBs and the special CB, which may improve mapping operations by the network node 110 associated with the regular CBs and the special CB, relative to using a CQI for the NR mapper as a substitute for the CQI of the special CB. For example, CQI may be computed in accordance with an RI and a PMI, and the RI and PMI may be different for the NR mapper than for the SC-MIMO mapper. Consequently, using the CQI of the NR mapper as a substitute for CQI of the special CB may be associated with poor CQI estimation, relative to using the SC-MIMO mapper for CQI computation.

In some cases, the UE 120 may be configured to evaluate CQI for a large quantity of regular CBs and a regular CB corresponding to a CQI report band 610. However, a CSI subband report corresponding to a CQI report band 610 may have a size (e.g., in a quantity of physical RBs (PRBs)) that is based on a BWP size (e.g., a BWP bandwidth) associated with the CQI report band 610. Consequently, the CSI subband report should be configured to have a size that supports a large quantity of regular CBs. Accordingly, in some aspects, the UE 120 may be configured with a CSI subband report size from a size selected in accordance with Table 1 below. Therefore, the network node 110 may select a largest size for a CSI subband report size when a large quantity of CBs are configured for a CQI report band 610.

TABLE 1
CSI Subband Report Sizes for BWP Size

| BWP Size (PRBs) | CSI Subband Report Size (PRBs) |
|---|---|
| 24-72 | 4, 8, 16 |
| 73-144 | 8, 16, 32 |
| 145-275 | 16, 32, 64 |

As indicated above, FIG. 6 is provided as an example. Other examples may differ from what is described with respect to FIG. 6. For example, Table 1 may include a different range of values for the BWP size, different values for the CSI subband report size per BWP size, or a combination thereof.

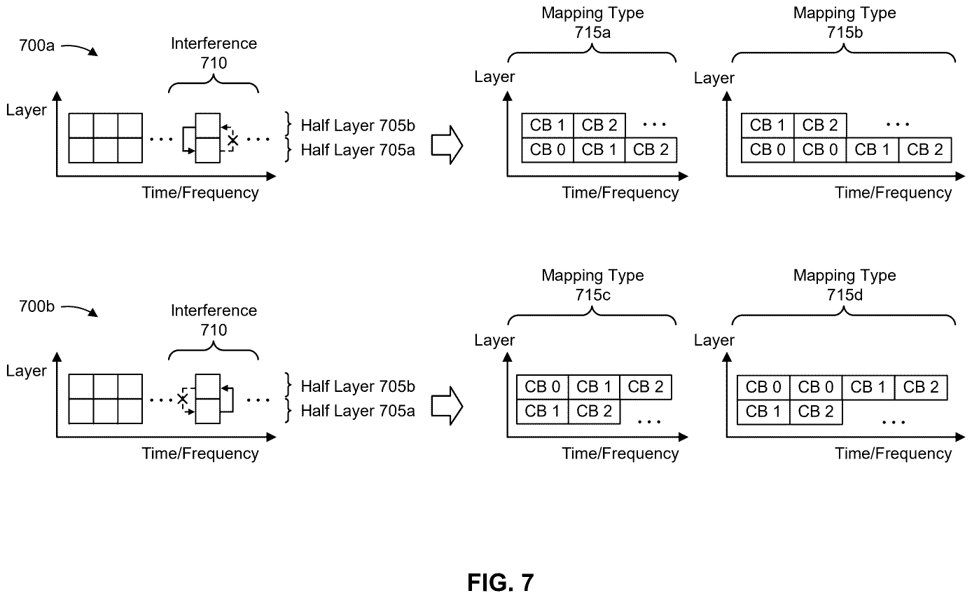

FIG. 7 is a diagram illustrating a first example 700a and a second example 700b of assumptions associated with CQI computation for regular CBs in accordance with SC-MIMO techniques.

In some examples, the UE 120 may be configured to compute CQI for regular CBs mapped to one or more resources (e.g., of a PDSCH) across one or more half layers 705, as described herein. In some cases, regular CBs on a first half layer 705a may experience interference 710 (e.g., inter-CB interference, or inter-layer interference) from CBs on a second half layer 705b. Additionally, or alternatively, regular CBs on the second half layer 705b may experience interference 710 from CBs on the first half layer 705a. In some aspects, the UE 120 may be configured to make an assumption associated with the interference 710 experienced by regular CBs.

The first example 700a depicts a first assumption associated with CQI computing for regular CBs. For example, in accordance with the first assumption, the UE 120 may assume that portions of regular CBs located on the first half layer 705a experience interference 710 from CBs on corresponding resources of the second half layer 705b when computing CQI for portions of the regular CBs located on the first half layer 705a. Additionally, the UE 120 may assume that portions of regular CBs located on the second half layer 705b do not experience interference from CBs located on corresponding resources of the first half layer 705a when computing CQI for the portions of regular CBs located on the second half layer 705b.

In some aspects, the first assumption may correspond to one or more mapping types 715 associated with CB-to-layer mappings in accordance with SC-MIMO techniques. For example, the first assumption may correspond to a mapping type 715a and a mapping type 715b, which may be examples of right-to-left diagonal mappings, as described with reference to FIG. 5. When the UE 120 initiates an SC-MIMO decoding chain, as described with reference to FIG. 4, the UE 120 may decode and subtract the special CB (e.g., CB 0, or an initial CB), which may result in interference 710 being mitigated for a first portion of at least one regular CB (e.g., CB 1 for the mapping type 715a, or CB1 and CB 2 for the mapping type 715b) on the second half layer 705b. Similarly, as the UE 120 continues to decode and subtract CBs, interference 710 for portions of regular CBs on the second half layer 705b may be mitigated in accordance with the SC-MIMO decoding chain. Accordingly, the first assumption may be an effective assumption for performing CQI computing for CBs associated with the mapping type 715a or the mapping type 715b (or other mapping types, such as right-to-left diagonal mapping types).

The second example 700b depicts a second assumption associated with CQI computing for regular CBs. For example, in accordance with the second assumption, the UE 120 may assume that portions of regular CBs located on the second half layer 705b experience interference 710 from CBs on corresponding resources of the first half layer 705a when computing CQI for portions of the regular CBs located on the second half layer 705b. Additionally, the UE 120 may assume that portions of regular CBs located on the first half layer 705a do not experience interference from CBs located on corresponding resources of the second half layer 705b when computing CQI for the portions of regular CBs located on the first half layer 705a.

In some aspects, the second assumption may correspond to one or more mapping types 715 associated with CB-to-layer mappings in accordance with SC-MIMO techniques. For example, the first assumption may correspond to a mapping type 715c and a mapping type 715d, which may be examples of left-to-right diagonal mappings, as described with reference to FIG. 5. When the UE 120 initiates an SC-MIMO decoding chain, as described with reference to FIG. 4, the UE 120 may decode and subtract the special CB (e.g., CB 0, or an initial CB), which may result in interference 710 being mitigated for a first portion of at least one regular CB (e.g., CB 1 for the mapping type 715c, or CB1 and CB 2 for the mapping type 715d) on the first half layer 705a. Similarly, as the UE 120 continues to decode and subtract CBS, interference 710 for portions of regular CBs on the first half layer 705a may be mitigated in accordance with the SC-MIMO decoding chain. Accordingly, the second assumption may be an effective assumption for performing CQI computing for CBs associated with the mapping type 715c or the mapping type 715d (or other mapping types, such as left-to-right diagonal mapping types).

In some aspects, the UE 120 may receive an indication of an assumption to use for CQI computing for regular CBs using the SC-MIMO mapper. For example, a network node 110 may transmit, to the UE 120, a configuration (e.g., a CSI reporting configuration, an RRC configuration, an RRC reconfiguration) that indicates the assumption (e.g., the first assumption or the second assumption) that the UE 120 should make for computing CQI for the regular CBs. In some aspects, the UE 120 may use all layers (e.g., all half layers 705) when computing CQI for the regular CBs regardless of the assumption made by the UE 120. For example, the CQI may be computed for the regular CBs by averaging one or more spectral efficiency values over all layers (e.g., all half layers 705).

As indicated above, FIG. 7 is provided as an example. Other examples may differ from what is described with respect to FIG. 7. For example, while the example 700a and the example 700b illustrate assumptions with respect to half layers 705, the techniques described herein may be applied to CB mappings across full layers, or mappings associated with a different quantity of half layers 705. Additionally, or alternatively, each assumption described with respect to FIG. 7 may correspond to additional mapping types 715 not shown.

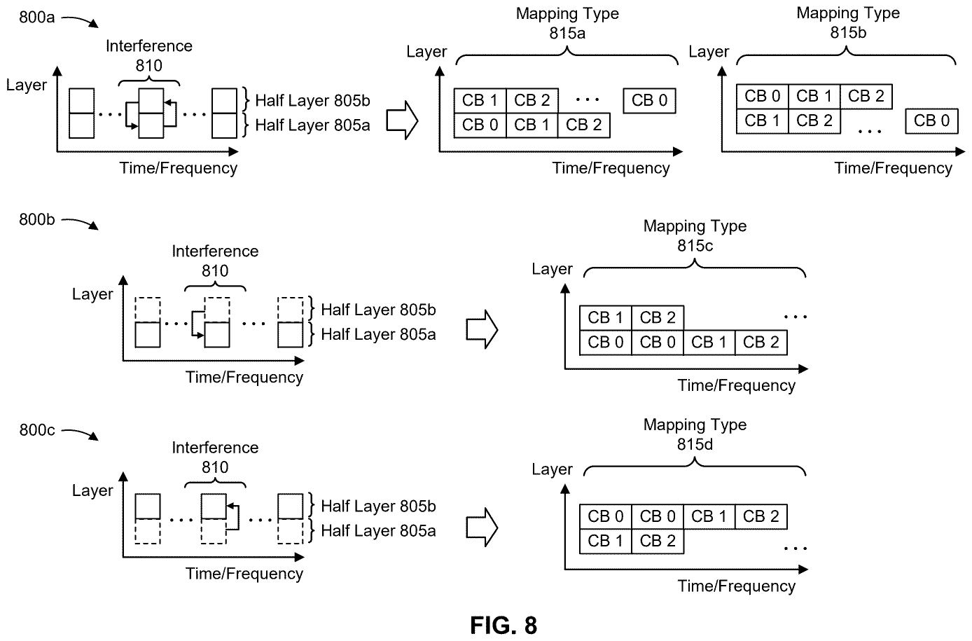

FIG. 8 is a diagram illustrating a first example 800a, a second example 800b, and a third example 800c of assumptions associated with CQI computation for a special CB in accordance with SC-MIMO techniques.

In some examples, the UE 120 may be configured to compute CQI for a special CB mapped to one or more resources (e.g., of a PDSCH) across one or more half layers 805, as described herein. In some cases, resources on a first half layer 805a may experience interference 810 (e.g., inter-layer interference) from transmissions on corresponding resources of a second half layer 805b. Additionally, or alternatively, resources on the second half layer 805b may experience interference 810 from transmissions on corresponding resources of the first half layer 805a. In some aspects, the UE 120 may be configured to make an assumption associated with the interference 810 experienced by each half layer 805.

The first example 800a depicts a first assumption associated with CQI computing for the special CB. For example, in accordance with the first assumption, the UE 120 may assume that all half layers 805 (e.g., all layers) experience interference 810 (e.g., from other half layers 805). For example, the first half layer 805a may experience interference 810 from the second half layer 805b, and the second half layer 805b may experience interference 810 from the first half layer 805a. In some aspects, when computing CQI for the special CB in accordance with the first assumption, the UE 120 may use all half layers 805 to compute the CQI of the special CB. For example, the UE 120 may average one or more spectral efficiency values over all half layers 805.

In some aspects, the first assumption may correspond to one or more mapping types 815 associated with CB-to-layer mappings in accordance with SC-MIMO techniques. For example, the first assumption may correspond to a mapping type 815a and a mapping type 815b, which may be examples of mappings where the special CB is located across the first half layer 805a and the second half layer 805b. For example, both a first portion and a second portion of the special CB may experience interference 810 from another CB (e.g., a regular CB). Accordingly, the first assumption may be an effective assumption for performing CQI computing for CBs associated with the mapping type 815a or the mapping type 815b (other mapping types where the special CB is mapped across multiple layers).

The second example 800b depicts a second assumption associated with CQI computing for the special CB. For example, in accordance with the second assumption, the UE 120 may assume that the first half layer 805a experiences interference 810 from other half layers 805 (e.g., from the second half layer 805b). In some aspects, when computing CQI for the special CB in accordance with the second assumption, the UE 120 may use the first half layers 805a (e.g., only the first half layers 805a) to compute the CQI of the special CB. For example, the UE 120 may average one or more spectral efficiency values over the first half layer 805a to compute the CQI of the special CB.

In some aspects, the second assumption may correspond to one or more mapping types 815 associated with CB-to-layer mappings in accordance with SC-MIMO techniques. For example, the second assumption may correspond to a mapping type 815c, which may be an example of a mapping where the special CB is mapped only on the first half layer 805a. For example, both a first portion and a second portion of the special CB may be located on the first half layer 805a, and may experience interference 810 from other CBs (e.g., a regular CB) on the second half layer 805b. Accordingly, the second assumption may be an effective assumption for performing CQI computing for CBs associated with the mapping type 815c (or other mapping types where the special CB is mapped only on the first half layer 805a).

The third example 800c depicts a third assumption associated with CQI computing for the special CB. For example, in accordance with the third assumption, the UE 120 may assume that the second half layer 805b experiences interference 810 from other half layers 805 (e.g., from the first half layer 805a). In some aspects, when computing CQI for the special CB in accordance with the third assumption, the UE 120 may use the second half layers 805b (e.g., only the second half layers 805b) to compute the CQI of the special CB. For example, the UE 120 may average one or more spectral efficiency values over the second half layer 805b to compute the CQI of the special CB.

In some aspects, the third assumption may correspond to one or more mapping types 815 associated with CB-to-layer mappings in accordance with SC-MIMO techniques. For example, the second assumption may correspond to a mapping type 815d, which may be an example of a mapping where the special CB is mapped only on the second half layer 805b. For example, both a first portion and a second portion of the special CB may be located on the second half layer 805b, and may experience interference 810 from other CBs (e.g., a regular CB) on the first half layer 805a. Accordingly, the third assumption may be an effective assumption for performing CQI computing for CBs associated with the mapping type 815d (or other mapping types where the special CB is mapped only on the second half layer 805b).

In some aspects, the UE 120 may receive an indication of an assumption to use for CQI computing for the special CB using the SC-MIMO mapper. For example, a network node 110 may transmit, to the UE 120, a configuration (e.g., a CSI reporting configuration, an RRC configuration, an RRC reconfiguration) that indicates the assumption (e.g., the first assumption, the second assumption, or the third assumption) that the UE 120 should make for computing CQI for the special CB.

As indicated above, FIG. 8 is provided as an example. Other examples may differ from what is described with respect to FIG. 8. For example, while the example 800a and the example 800b illustrate assumptions with respect to half layers 805, the techniques described herein may be applied to CB mappings across full layers, or mappings associated with a different quantity of half layers 805. Additionally, or alternatively, each assumption described with respect to FIG. 8 may correspond to additional mapping types 815 not shown.

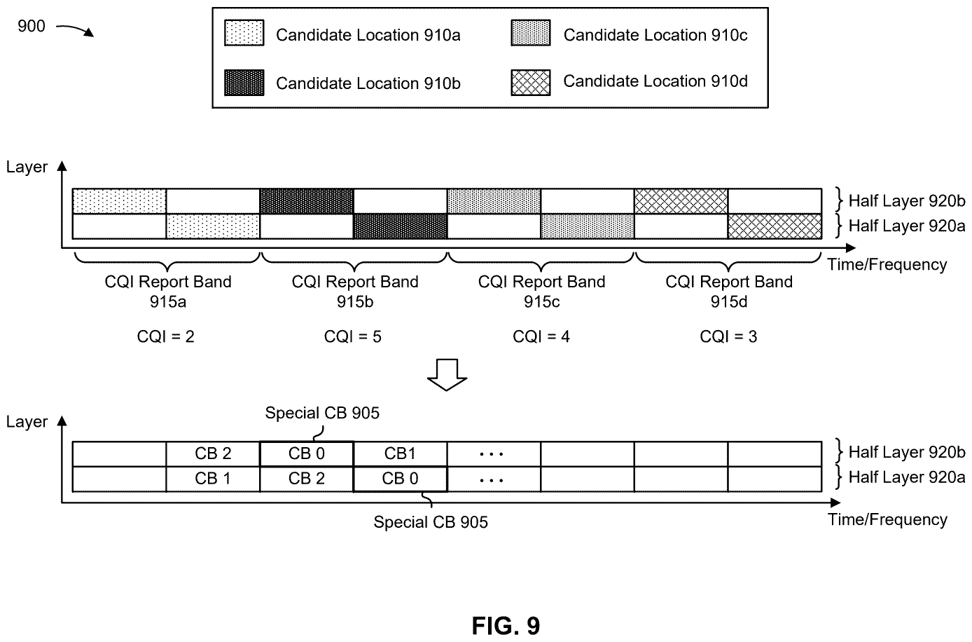

FIG. 9 is a diagram illustrating an example 900 of CQI reporting for candidate special CB locations. In an SC-MIMO decoding chain, a UE 120 may begin by decoding a special CB 905 (e.g., an initial CB, or CB 0). However, when one or more resources associated with the special CB are associated with poor channel quality, the UE 120 may experience errors when decoding the special CB. Additionally, as the special CB 905 is decoded first and then subtracted for decoding of subsequent regular CBs, errors in the decoding of the special CB 905 may be propagated across the SC-MIMO decoding chain, resulting in poor decoding. Accordingly, selecting a location for the special CB 905 that is likely to experience higher channel quality than other locations may improve decoding performance for all regular CBs in the SC-MIMO decoding chain.

In some aspects, the UE 120 may be configured with one or more candidate locations 910 associated with the special CB 905. For example, a network node 110 may transmit a configuration (e.g., a CSI reporting configuration, or another configuration) that indicates the one or more candidate locations 910, such as a first candidate location 910a, a second candidate location 910b, a third candidate location 910c, and a fourth candidate location 910d. For example, the configuration may indicate one or more CQI report bands 915, and each CQI report band may correspond to a candidate location 910 for the special CB. For instance, the configuration may indicate a CQI report band 915a corresponding to the first candidate location 910a, a CQI report band 915b corresponding to the second candidate location 910b, a CQI report band 915c corresponding to the third candidate location 910c, and a CQI report band 915d corresponding to the fourth candidate location 910d. Additionally, or alternatively, the configuration may configure the UE 120 to report CQI for each of the one or more candidate locations 910.

In some aspects, the configuration may indicate which half layers 920 may be used by the UE 120 to compute the CQI for the candidate locations 910 (e.g., for averaging spectral efficiency values). For example, the configuration may indicate that the UE 120 should use only a first half layer 920a, only a second half layer 920b, both the first half layer 920a and the second half layer 920b in a left-to-right diagonal pattern, or both the first half layer 920a and the second half layer 920b in a right-to-left diagonal pattern. In some aspects, the UE 120 may assume that all layers (e.g., the first half layer 920a and the second half layer 920b) experience inter-layer interference when computing the CQI for the candidate locations 910.

As shown in FIG. 9, the UE 120 may use both the first half layer 920a and the second half layer 920b in a right-to-left diagonal pattern for computing the CQI for the candidate locations 910. For example, the layers and pattern to use for the CQI computing may be in accordance with a pattern associated with the candidate locations 910 for the special CB. After computing the CQI, the UE 120 may report (e.g., via a CSI report) the CQI for each CQI report band 915. For instance, the UE 120 may report that a CQI value for the CQI report band 915b is larger than CQI values for other CQI report bands 915. Accordingly, the network node 110 may configure the UE 120 with a special CB location that corresponds to the candidate location 910b associated with the CQI report band 915b in accordance with the CQI report band 915b having the largest CQI value. Consequently, the special CB 905 may be located at the candidate location 910b, which may be more likely to experience better channel quality conditions relative to other candidate locations 910.

As indicated above, FIG. 9 is provided as an example. Other examples may differ from what is described with respect to FIG. 9. For example, while the example 900 illustrates a right-to-left candidate location mapping, different candidate location mappings may be used. Additionally, or alternatively, a different quantity of half layers 920 may be used for the special CB mapping, or full layers may be used instead of half layers 920.

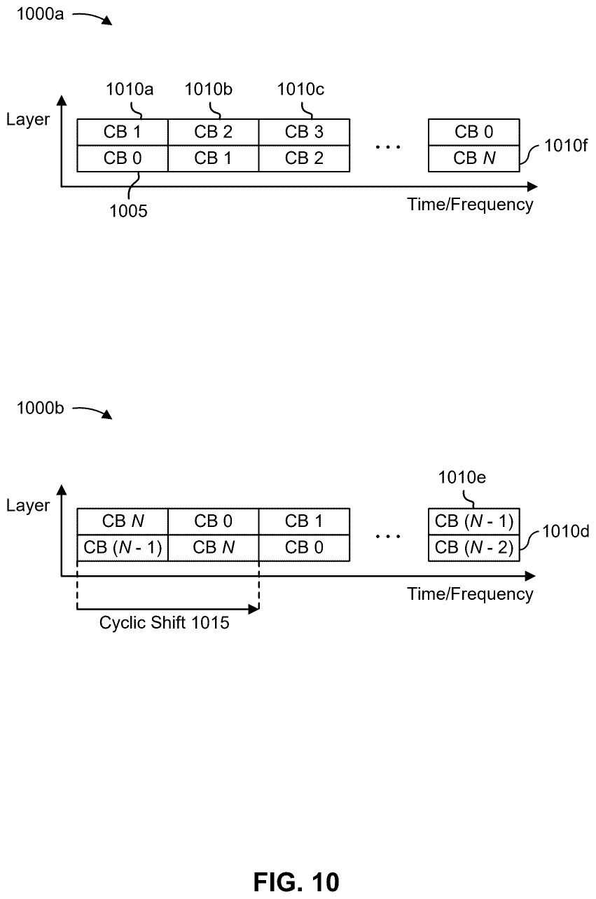

FIG. 10 is a diagram illustrating an example 1000a and an example 1000b associated with CB mappings for SC-MIMO techniques.

In some examples, the UE 120 may receive a PDCCH message (e.g., from a network node 110) that may schedule a PDSCH message, and an SC-MIMO mapper associated with the UE 120 may map a special CB 1005 and one or more regular CBs 1010 to one or more resources associated with the PDSCH message. For example, the PDSCH message may include a first regular CB 1010a (e.g., CB 1), a second regular CB 1010b (e.g., CB 2), a third regular CB 1010c (e.g., CB 3), a fourth regular CB 1010d (e.g., CB N−2), a fifth regular CB 1010e (e.g., a CB N−1), and a sixth regular CB 1010f (e.g., CB N).

In some aspects, the PDCCH that schedules the PDSCH message may indicate an MCS of the regular CBs 1010 (e.g., MCS_{rg}). Additionally, or alternatively, the PDCCH message may indicate an MCS of the special CB 1005 (e.g., MCSₛₚ). When the PDCCH message does not include the MCS of the special CB 1005, the UE 120 may obtain the MCS of the special CB 1005 in accordance with an offset value and the MCS of the regular CBs 1010. For example, the UE 120 may be configured with the offset value (e.g., by the network node 110, such as via an RRC configuration or an RRC reconfiguration, or the offset value may be defined in a standard), and the MCS of the special CB 1005 may be calculated in accordance with Equation 1 below:

$$M C {S}_{s p} = M C {S}_{r g} - k \qquad ( 1 )$$

where k corresponds to the offset value.

Additionally, or alternatively, the PDCCH message may indicate a location of the special CB 1005. For example, the PDCCH message may indicate a location of a first portion of the special CB 1005, a second portion of the special CB 1005, or both. Additionally, or alternatively, the PDCCH message may indicate an RE corresponding to at least one portion of the special CB 1005. For example, the PDCCH message may indicate an RE corresponding to the first portion of the special CB 1005, and the second portion of the special CB 1005 may be mapped by the UE 120 to an RE in accordance with a CB mapping (e.g., previously configured to the UE 120).

In some aspects, the location of the regular CBs 1010 may be obtained from the location of the special CB 1005. For example, the special CB 1005 may be mapped to a first position, and the regular CBs 1010 may be mapped in accordance with a CB mapping, as described with reference to FIGS. 3 through 5. In the example 1000b, the special CB 1005 may be located at a position that is shifted by 2 REs relative to the example 1000a. Accordingly, a cyclic shift 1015 may be applied to the regular CBs in accordance with the position of the special CB 1005. For example, in the example 1000b, each of the regular CBs 1010 may be shifted by 2 REs relative to corresponding position in the example 1000a. Accordingly, the SC-MIMO mapper may map the regular CBs 1010 onto the resources associated with the PDSCH message starting from an n^{th} RE instead of a first RE in accordance with the position of the special CB 1005 being shifted by n−1 REs, resulting in shifting the regular CBs 1010 by n−1 REs. In some cases, when the PDCCH does not indicate a position of the special CB 1005, the UE 120 may map the special CB 1005 to a default location configured in a specification or configured to the UE 120 by the network node 110 (e.g., via an RRC configuration or an RRC reconfiguration).

Additionally, or alternatively, the PDCCH message may indicate a mapping type (e.g., a diagonal CB-to-layer mapping type) associated with mapping the special CB and the regular CBs 1010 to the resources associated with the PDSCH message. For example, the PDCCH message may indicate a mapping type from a set of mapping types for SC-MIMO CB mappings. In some examples, the set of mapping types may include the mappings described with respect to FIG. 5, or other mappings.

As indicated above, FIG. 10 is provided as an example. Other examples may differ from what is described with respect to FIG. 10. For example, the techniques described with respect to FIG. 10 may be applied to different CB mappings, as described herein, or different cyclic shift values may be used. In some cases, when the PDCCH does not indicate a mapping type, the UE 120 may map the CBs in accordance with a default location configured in a specification or configured to the UE 120 by the network node 110 (e.g., via an RRC configuration or an RRC reconfiguration).

FIG. 11 is a diagram illustrating an example process 1100 performed, for example, at a UE or an apparatus of a UE. Example process 1100 is an example where the apparatus or the UE (e.g., UE 120) performs operations associated with CQI computing and reporting for SC-MIMO.

As shown in FIG. 11, in some aspects, process 1100 may include receiving, from a network node, a configuration associated with SC-MIMO communications, where the configuration is associated with an initial code block and one or more regular code blocks for one or more bands configured for CSI reporting (block 1110). For example, the UE (e.g., using reception component 1302 or communication manager 1306, depicted in FIG. 13) may receive, from a network node, a configuration associated with SC-MIMO communications, where the configuration is associated with an initial code block and one or more regular code blocks for one or more bands configured for CSI reporting, as described above, such as with respect to the special CB 405 and regular CBs 410 of FIG. 4.

As further shown in FIG. 11, in some aspects, process 1100 may include transmitting, to the network node and in accordance with the configuration, a CSI report that includes, for each band of the one or more bands, a respective pair of CQI values, where a first CQI value of the respective pair of CQI values corresponds to the one or more regular code blocks, and a second CQI value of the respective pair of CQI values corresponds to the initial code block (block 1120). For example, the UE (e.g., using transmission component 1304 or communication manager 1306, depicted in FIG. 13) may transmit, to the network node and in accordance with the configuration, a CSI report that includes, for each band of the one or more bands, a respective pair of CQI values, where a first CQI value of the respective pair of CQI values corresponds to the one or more regular code blocks, and a second CQI value of the respective pair of CQI values corresponds to the initial code block, as described above, such as with respect to pairs of CQI values 620 of FIG. 6.

Process 1100 may include additional aspects, such as any single aspect or any combination of aspects described below or in connection with one or more other processes described elsewhere herein.

In a first aspect, the configuration is associated with a diagonal mapping across a first half layer and a second half layer and, for each code block of the one or more regular code blocks and the initial code block, a first portion of the code block corresponds to a first set of resources on the first half layer and a second portion of the code block corresponds to a second set of resources on the second half layer in accordance with the diagonal mapping (e.g., as described with reference to FIGS. 3 through 5).

In a second aspect, alone or in combination with the first aspect, the configuration indicates an assumption associated with CQI computing for the one or more regular code blocks using the first half layer and the second half layer, and the assumption comprises that the first half layer experiences interference from the second half layer and that the second half layer does not experience interference from the first half layer (e.g., as described with reference to FIG. 7-8).

In a third aspect, alone or in combination with one or more of the first and second aspects, the configuration indicates an assumption associated with CQI computing for the initial code block using the first half layer and the second half layer, and the assumption comprises that the first half layer experiences interference from the second half layer and that the second half layer experiences interference from the first half layer (e.g., as described with reference to FIG. 7-8).

In a fourth aspect, alone or in combination with one or more of the first through third aspects, the configuration indicates an assumption associated with CQI computing for the initial code block using the first half layer, where the assumption comprises that the first half layer experiences interference from the second half layer (e.g., as described with reference to FIG. 8).

In a fifth aspect, alone or in combination with one or more of the first through fourth aspects, the CSI report includes one or more CQI values corresponding to one or more candidate resources associated with the initial code block in accordance with the configuration (e.g., as described with reference to FIG. 9).

In a sixth aspect, alone or in combination with one or more of the first through fifth aspects, the configuration indicates a pattern associated with CQI computing for the one or more candidate resources, and the pattern is selected from a first half layer pattern, a second half layer pattern, a left-to-right diagonal pattern, or a right-to-left diagonal pattern (e.g., as described with reference to FIGS. 5 and 10).

In a seventh aspect, alone or in combination with one or more of the first through sixth aspects, the one or more regular code blocks and the initial code block are mapped to one or more resources of a PDSCH (e.g., as described with reference to FIG. 10).

In an eighth aspect, alone or in combination with one or more of the first through seventh aspects, process 1100 includes receiving a PDCCH message that schedules a PDSCH message on the one or more resources of the PDSCH, where the PDCCH message indicates a first modulation and coding scheme associated with the one or more regular code blocks, and receiving the PDSCH message in accordance with the first modulation and coding scheme (e.g., as described with reference to FIG. 10).

In a ninth aspect, alone or in combination with one or more of the first through eighth aspects, the PDCCH message indicates a second modulation and coding scheme associated with the initial code block (e.g., as described with reference to FIG. 10).

In a tenth aspect, alone or in combination with one or more of the first through ninth aspects, the configuration indicates an offset, and a second modulation and coding scheme associated with the initial code block is obtained in accordance with the offset and the first modulation and coding scheme (e.g., as described with reference to FIG. 10).

In an eleventh aspect, alone or in combination with one or more of the first through tenth aspects, the PDCCH message indicates a location of the initial code block on the one or more resources of the PDSCH, and a location of the one or more regular code blocks is shifted in accordance with the location of the initial code block (e.g., as described with reference to FIG. 10).

In a twelfth aspect, alone or in combination with one or more of the first through eleventh aspects, the configuration indicates a location of the initial code block on the one or more resources of the PDSCH, e.g., as described with reference to FIG. 10.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with CQI computing and reporting for SC-MIMO.

As shown in FIG. 12, in some aspects, process 1200 may include transmitting, to a UE, a configuration associated with SC-MIMO communications, where the configuration is associated with an initial code block and one or more regular code blocks for one or more bands configured for CSI reporting (block 1210). For example, the network node (e.g., using transmission component 1404 or communication manager 1406, depicted in FIG. 14) may transmit, to a UE, a configuration associated with SC-MIMO communications, where the configuration is associated with an initial code block and one or more regular code blocks for one or more bands configured for CSI reporting, as described above, such as with respect to the special CB 405 and regular CBs 410 of FIG. 4.

As further shown in FIG. 12, in some aspects, process 1200 may include receiving, from the UE and in accordance with the configuration, a CSI report that includes, for each band of the one or more bands, a respective pair of CQI values, where a first CQI value of the respective pair of CQI values corresponds to the one or more regular code blocks, and a second CQI value of the respective pair of CQI values corresponds to the initial code block (block 1220). For example, the network node (e.g., using reception component 1402 or communication manager 1406, depicted in FIG. 14) may receive, from the UE and in accordance with the configuration, a CSI report that includes, for each band of the one or more bands, a respective pair of CQI values, where a first CQI value of the respective pair of CQI values corresponds to the one or more regular code blocks, and a second CQI value of the respective pair of CQI values corresponds to the initial code block, as described above, such as with respect to pairs of CQI values 620 of FIG. 6.

Process 1200 may include additional aspects, such as any single aspect or any combination of aspects described below or in connection with one or more other processes described elsewhere herein.

In a first aspect, the configuration is associated with a diagonal mapping across a first half layer and a second half layer and, for each code block of the one or more regular code blocks and the initial code block, a first portion of the code block corresponds to a first set of resources on the first half layer and a second portion of the code block corresponds to a second set of resources on the second half layer in accordance with the diagonal mapping (e.g., as described with reference to FIGS. 3 through 5).

In a second aspect, alone or in combination with the first aspect, the configuration indicates an assumption associated with CQI computing for the one or more regular code blocks using the first half layer and the second half layer, and the assumption comprises that the first half layer experiences interference from the second half layer and that the second half layer does not experience interference from the first half layer (e.g., as described with reference to FIGS. 7 through 8).

In a third aspect, alone or in combination with one or more of the first and second aspects, the configuration indicates an assumption associated with CQI computing for the initial code block using the first half layer and the second half layer, and the assumption comprises that the first half layer experiences interference from the second half layer, and that the second half layer experiences interference from the first half layer (e.g., as described with reference to FIGS. 7 through 8).

In a fourth aspect, alone or in combination with one or more of the first through third aspects, the configuration indicates an assumption associated with CQI computing for the initial code block using the first half layer, where the assumption comprises that the first half layer experiences interference from the second half layer (e.g., as described with reference to FIG. 8).

In a fifth aspect, alone or in combination with one or more of the first through fourth aspects, the CSI report includes one or more CQI values corresponding to one or more candidate resources associated with the initial code block in accordance with the configuration (e.g., as described with reference to FIG. 9).

In a sixth aspect, alone or in combination with one or more of the first through fifth aspects, the configuration indicates a pattern associated with CQI computing for the one or more candidate resources, and the pattern is selected from a first half layer pattern, a second half layer pattern, a left-to-right diagonal pattern, or a right-to-left diagonal pattern (e.g., as described with reference to FIGS. 5 and 10).

In a seventh aspect, alone or in combination with one or more of the first through sixth aspects, the one or more regular code blocks and the initial code block are mapped to one or more resources of a PDSCH (e.g., as described with reference to FIG. 10).

In an eighth aspect, alone or in combination with one or more of the first through seventh aspects, process 1200 includes transmitting a PDCCH message that schedules a PDSCH message on the one or more resources of the PDSCH, where the PDCCH message indicates a first modulation and coding scheme associated with the one or more regular code blocks, and transmitting the PDSCH message in accordance with the first modulation and coding scheme (e.g., as described with reference to FIG. 10).

In a ninth aspect, alone or in combination with one or more of the first through eighth aspects, the PDCCH message indicates a second modulation and coding scheme associated with the initial code block (e.g., as described with reference to FIG. 10).

In a tenth aspect, alone or in combination with one or more of the first through ninth aspects, the configuration indicates an offset, and a second modulation and coding scheme associated with the initial code block is obtained in accordance with the offset and the first modulation and coding scheme (e.g., as described with reference to FIG. 10).

In an eleventh aspect, alone or in combination with one or more of the first through tenth aspects, the PDCCH message indicates a location of the initial code block on the one or more resources of the PDSCH, and a location of the one or more regular code blocks is shifted in accordance with the location of the initial code block (e.g., as described with reference to FIG. 10).

In a twelfth aspect, alone or in combination with one or more of the first through eleventh aspects, the configuration indicates a location of the initial code block on the one or more resources of the PDSCH (e.g., as described with reference to FIG. 10).

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 4 through 10. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive, from a network node, a configuration associated with SC-MIMO communications, wherein the configuration is associated with an initial code block and one or more regular code blocks for one or more bands configured for CSI reporting. The transmission component 1304 may transmit, to the network node and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

The reception component 1302 may receive a PDCCH message that schedules a PDSCH message on the one or more resources of the PDSCH, wherein the PDCCH message indicates a first modulation and coding scheme associated with the one or more regular code blocks.

The reception component 1302 may receive the PDSCH message in accordance with the first modulation and coding scheme.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 4 through 10. Additionally, or alternatively, the apparatus 1400 may be configured to perform one or more processes described herein, such as process 1200 of FIG. 12. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit, to a UE, a configuration associated with SC-MIMO communications, wherein the configuration is associated with an initial code block and one or more regular code blocks for one or more bands configured for CSI reporting. The reception component 1402 may receive, from the UE and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

The transmission component 1404 may transmit a PDCCH message that schedules a PDSCH message on the one or more resources of the PDSCH, wherein the PDCCH message indicates a first modulation and coding scheme associated with the one or more regular code blocks.

The transmission component 1404 may transmit the PDSCH message in accordance with the first modulation and coding scheme.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving, from a network node, a configuration associated with SC-MIMO communications, wherein the configuration is associated with an initial code block and one or more regular code blocks for one or more bands configured for CSI reporting; and transmitting, to the network node and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Aspect 2: The method of Aspect 1, wherein the configuration is associated with a diagonal mapping across a first half layer and a second half layer, and wherein, for each code block of the one or more regular code blocks and the initial code block, a first portion of the code block corresponds to a first set of resources on the first half layer and a second portion of the code block corresponds to a second set of resources on the second half layer in accordance with the diagonal mapping.

Aspect 3: The method of Aspect 2, wherein the configuration indicates an assumption associated with CQI computing for the one or more regular code blocks using the first half layer and the second half layer, and wherein the assumption comprises that the first half layer experiences interference from the second half layer and that the second half layer does not experience interference from the first half layer.

Aspect 4: The method of Aspect 2, wherein the configuration indicates an assumption associated with CQI computing for the initial code block using the first half layer and the second half layer, and wherein the assumption comprises that the first half layer experiences interference from the second half layer and that the second half layer experiences interference from the first half layer.

Aspect 5: The method of Aspect 2, wherein the configuration indicates an assumption associated with CQI computing for the initial code block using the first half layer, wherein the assumption comprises that the first half layer experiences interference from the second half layer.

Aspect 6: The method of any of Aspects 1-5, wherein the CSI report includes one or more CQI values corresponding to one or more candidate resources associated with the initial code block in accordance with the configuration.

Aspect 7: The method of Aspect 6, wherein the configuration indicates a pattern associated with CQI computing for the one or more candidate resources, and wherein the pattern is selected from a first half layer pattern, a second half layer pattern, a left-to-right diagonal pattern, or a right-to-left diagonal pattern.

Aspect 8: The method of any of Aspects 1-7, wherein the one or more regular code blocks and the initial code block are mapped to one or more resources of a PDSCH.

Aspect 9: The method of Aspect 8, further comprising: receiving a PDCCH message that schedules a PDSCH message on the one or more resources of the PDSCH, wherein the PDCCH message indicates a first modulation and coding scheme associated with the one or more regular code blocks; and receiving the PDSCH message in accordance with the first modulation and coding scheme.

Aspect 10: The method of Aspect 9, wherein the PDCCH message indicates a second modulation and coding scheme associated with the initial code block.

Aspect 11: The method of Aspect 9, wherein the configuration indicates an offset, and wherein a second modulation and coding scheme associated with the initial code block is obtained in accordance with the offset and the first modulation and coding scheme.

Aspect 12: The method of Aspect 9-11, wherein the PDCCH message indicates a location of the initial code block on the one or more resources of the PDSCH, and wherein a location of the one or more regular code blocks is shifted in accordance with the location of the initial code block.

Aspect 13: The method of Aspect 8, wherein the configuration indicates a location of the initial code block on the one or more resources of the PDSCH.

Aspect 14: A method of wireless communication performed by a network node, comprising: transmitting, to a UE, a configuration associated with SC-MIMO communications, wherein the configuration is associated with an initial code block and one or more regular code blocks for one or more bands configured for CSI reporting; and receiving, from the UE and in accordance with the configuration, a CSI report that includes, for each band of the one or more bands, a respective pair of CQI values, wherein a first CQI value of the respective pair of CQI values corresponds to the one or more regular code blocks, and a second CQI value of the respective pair of CQI values corresponds to the initial code block.

Aspect 15: The method of Aspect 14, wherein the configuration is associated with a diagonal mapping across a first half layer and a second half layer, and wherein, for each code block of the one or more regular code blocks and the initial code block, a first portion of the code block corresponds to a first set of resources on the first half layer and a second portion of the code block corresponds to a second set of resources on the second half layer in accordance with the diagonal mapping.

Aspect 16: The method of Aspect 15, wherein the configuration indicates an assumption associated with CQI computing for the one or more regular code blocks using the first half layer and the second half layer, and wherein the assumption comprises that the first half layer experiences interference from the second half layer and that the second half layer does not experience interference from the first half layer.

Aspect 17: The method of Aspect 15, wherein the configuration indicates an assumption associated with CQI computing for the initial code block using the first half layer and the second half layer, and wherein the assumption comprises that the first half layer experiences interference from the second half layer, and that the second half layer experiences interference from the first half layer.

Aspect 18: The method of Aspect 15, wherein the configuration indicates an assumption associated with CQI computing for the initial code block using the first half layer, wherein the assumption comprises that the first half layer experiences interference from the second half layer.

Aspect 19: The method of any of Aspects 14-18, wherein the CSI report includes one or more CQI values corresponding to one or more candidate resources associated with the initial code block in accordance with the configuration.

Aspect 20: The method of Aspect 19, wherein the configuration indicates a pattern associated with CQI computing for the one or more candidate resources, and wherein the pattern is selected from a first half layer pattern, a second half layer pattern, a left-to-right diagonal pattern, or a right-to-left diagonal pattern.

Aspect 21: The method of any of Aspects 14-20, wherein the one or more regular code blocks and the initial code block are mapped to one or more resources of a PDSCH.

Aspect 22: The method of Aspect 21, further comprising: transmitting a PDCCH message that schedules a PDSCH message on the one or more resources of the PDSCH, wherein the PDCCH message indicates a first modulation and coding scheme associated with the one or more regular code blocks; and transmitting the PDSCH message in accordance with the first modulation and coding scheme.

Aspect 23: The method of Aspect 22, wherein the PDCCH message indicates a second modulation and coding scheme associated with the initial code block.

Aspect 24: The method of Aspect 22, wherein the configuration indicates an offset, and wherein a second modulation and coding scheme associated with the initial code block is obtained in accordance with the offset and the first modulation and coding scheme.

Aspect 25: The method of Aspect 22-24, wherein the PDCCH message indicates a location of the initial code block on the one or more resources of the PDSCH, and wherein a location of the one or more regular code blocks is shifted in accordance with the location of the initial code block.

Aspect 26: The method of Aspect 21, wherein the configuration indicates a location of the initial code block on the one or more resources of the PDSCH.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

Aspect 34: A device comprising a processing system that includes one or more processors and one or more code-storing memories coupled with the one or more processors, the processing system configured to cause the device to perform the method of one or more of Aspects 1-26.

Aspect 35: A device comprising a processing system that includes processor circuitry and code-storing memory circuitry, the processing system configured to cause the device to perform the method of one or more of Aspects 1-26.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a configuration associated with spatially coupled multiple-input multiple-output (SC-MIMO) communications, wherein the configuration is associated with an initial code block and one or more regular code blocks for one or more bands configured for channel state information (CSI) reporting; and
transmit, to the network node and in accordance with the configuration, a CSI report that includes, for each band of the one or more bands, a respective pair of channel quality indicator (CQI) values, wherein a first CQI value of the respective pair of CQI values corresponds to the one or more regular code blocks, and a second CQI value of the respective pair of CQI values corresponds to the initial code block.

2. The UE of claim 1, wherein the configuration is associated with a diagonal mapping across a first half layer and a second half layer, and wherein, for each code block of the one or more regular code blocks and the initial code block, a first portion of the code block corresponds to a first set of resources on the first half layer and a second portion of the code block corresponds to a second set of resources on the second half layer in accordance with the diagonal mapping.

3. The UE of claim 2, wherein the configuration indicates an assumption associated with CQI computing for the one or more regular code blocks using the first half layer and the second half layer, and wherein the assumption comprises that the first half layer experiences interference from the second half layer and that the second half layer does not experience interference from the first half layer.

4. The UE of claim 2, wherein the configuration indicates an assumption associated with CQI computing for the initial code block using the first half layer and the second half layer, and wherein the assumption comprises that the first half layer experiences interference from the second half layer and that the second half layer experiences interference from the first half layer.

5. The UE of claim 2, wherein the configuration indicates an assumption associated with CQI computing for the initial code block using the first half layer, wherein the assumption comprises that the first half layer experiences interference from the second half layer.

6. The UE of claim 1, wherein the CSI report includes one or more CQI values corresponding to one or more candidate resources associated with the initial code block in accordance with the configuration.

7. The UE of claim 6, wherein the configuration indicates a pattern associated with CQI computing for the one or more candidate resources, and wherein the pattern is selected from a first half layer pattern, a second half layer pattern, a left-to-right diagonal pattern, or a right-to-left diagonal pattern.

8. The UE of claim 1, wherein the one or more regular code blocks and the initial code block are mapped to one or more resources of a physical downlink shared channel (PDSCH).

9. The UE of claim 8, wherein the processing system is configured to cause the UE to:
receive a physical downlink control channel (PDCCH) message that schedules a PDSCH message on the one or more resources of the PDSCH, wherein the PDCCH message indicates a first modulation and coding scheme associated with the one or more regular code blocks; and
receive the PDSCH message in accordance with the first modulation and coding scheme.

10. The UE of claim 9, wherein the PDCCH message indicates a second modulation and coding scheme associated with the initial code block.

11. The UE of claim 9, wherein the configuration indicates an offset, and wherein a second modulation and coding scheme associated with the initial code block is obtained in accordance with the offset and the first modulation and coding scheme.

12. The UE of claim 9, wherein the PDCCH message indicates a location of the initial code block on the one or more resources of the PDSCH, and wherein a location of the one or more regular code blocks is shifted in accordance with the location of the initial code block.

13. The UE of claim 8, wherein the configuration indicates a location of the initial code block on the one or more resources of the PDSCH.

14. A network node, comprising:
a processing system that includes one or more processors and one or more code-storing memories coupled with the one or more processors, the processing system configured to cause the network node to:
transmit, to a user equipment (UE), a configuration associated with spatially coupled multiple-input multiple-output (SC-MIMO) communications, wherein the configuration is associated with an initial code block and one or more regular code blocks for one or more bands configured for channel state information (CSI) reporting; and
receive, from the UE and in accordance with the configuration, a CSI report that includes, for each band of the one or more bands, a respective pair of channel quality indicator (CQI) values, wherein a first CQI value of the respective pair of CQI values corresponds to the one or more regular code blocks, and a second CQI value of the respective pair of CQI values corresponds to the initial code block.

15. The network node of claim 14, wherein the configuration is associated with a diagonal mapping across a first half layer and a second half layer, and wherein, for each code block of the one or more regular code blocks and the initial code block, a first portion of the code block corresponds to a first set of resources on the first half layer and a second portion of the code block corresponds to a second set of resources on the second half layer in accordance with the diagonal mapping.

16. The network node of claim 15, wherein the configuration indicates an assumption associated with CQI computing for the one or more regular code blocks using the first half layer and the second half layer, and wherein the assumption comprises that the first half layer experiences interference from the second half layer and that the second half layer does not experience interference from the first half layer.

17. The network node of claim 15, wherein the configuration indicates an assumption associated with CQI computing for the initial code block using the first half layer and the second half layer, and wherein the assumption comprises that the first half layer experiences interference from the second half layer, and that the second half layer experiences interference from the first half layer.

18. The network node of claim 15, wherein the configuration indicates an assumption associated with CQI computing for the initial code block using the first half layer, wherein the assumption comprises that the first half layer experiences interference from the second half layer.

19. The network node of claim 14, wherein the CSI report includes one or more CQI values corresponding to one or more candidate resources associated with the initial code block in accordance with the configuration.

20. A method of wireless communication performed by a user equipment (UE), comprising:
receiving, from a network node, a configuration associated with spatially coupled multiple-input multiple-output (SC-MIMO) communications, wherein the configuration is associated with an initial code block and one or more regular code blocks for one or more bands configured for channel state information (CSI) reporting; and
transmitting, to the network node and in accordance with the configuration, a CSI report that includes, for each band of the one or more bands, a respective pair of channel quality indicator (CQI) values, wherein a first CQI value of the respective pair of CQI values corresponds to the one or more regular code blocks, and a second CQI value of the respective pair of CQI values corresponds to the initial code block.
